(19) United States
(12) Patent Application Publication
(10) Pub. No.: US 2024/0281280 A1
(43) Pub. Date: Aug. 22, 2024

(54) Constraint policy and scheduling for a workload orchestration system

(71) Applicant: Ciena Corporation, Hanover, MD (US)

(72) Inventors: David Keith Bainbridge, Summerville, SC (US); Karthick Ramanarayanan, Fremont, CA (US)

(21) Appl. No.: 18/111,831

(22) Filed: Feb. 20, 2023

(51) Int. Cl. G06F 9/48

(52) U.S. Cl. CPC G06F 9/4881; G06F 9/5077; G06F 2209/485; G06F 2209/501; G06F 2209/506

(57) ABSTRACT

A workload orchestration system performs steps of receiving unassigned workloads for assignment on nodes for execution; and responsive to a scheduling trigger, scheduling the multiple unassigned workloads together considering one or more of resources on the nodes and a constraint policy for each of the unassigned workloads. The workload orchestration system can utilize Kubernetes and the one or more workloads are pods in Kubernetes. The scheduling trigger can include expiration of an amount of time where no new unassigned workloads are received. The constraint policy of at least two of the unassigned workloads can include a shared constraint.

### FIELD OF THE DISCLOSURE

The present disclosure relates generally to networking and computing. More particularly, the present disclosure relates to systems and methods for a constraint policy and scheduling for a workload orchestration system, such as Kubernetes.

### BACKGROUND OF THE DISCLOSURE

Kubernetes is an example workload orchestration system, configured for container orchestration for container orchestration to automate software deployment, scaling, and management. Kubernetes is maintained by the Cloud Native Computing Foundation. Kubernetes has a limited resource constraint model in that they have few pre-defined resource constrains (such as memory and processor resource, such as the number of processors required). As is known in the art, a constraint is a generally a requirement for a given workload, and a constraint model can be multiple requirements for the given workload. Kubernetes allows the addition of custom constraints with considerable restrictions on these extensions, i.e., that they must have an integer value and thus cannot be associated with a unit specifier. Additionally, the existing Kubernetes constraint model requires that the operator specifies the constraints on all workload (i.e., pod) definitions. This means that Kubernetes, today, does not allow an operator to define a common or shared set of constraints and them apply them to multiple workloads. Also, currently in Kubernetes, workloads (i.e., pods) are scheduled one at a time only considering workloads that are already scheduled and running. This can lead to sub-optimal scheduling when workloads are specified with resource constraints. There are no known solutions to allow workloads to be scheduled considering both already scheduled workloads and workloads that are not yet scheduled (pending).

### BRIEF SUMMARY OF THE DISCLOSURE

The present disclosure relates to systems and methods for a constraint policy and scheduling for a workload orchestration system, such as Kubernetes. In an embodiment, the present disclosure adds an extensible constraint policy model to a workload orchestration system, such as Kubernetes. In another embodiment, the present disclosure includes a workload (pod) scheduling process that can delay scheduling of workloads until a trigger is detected at which point the workload scheduling is completed (continues) based on a plan derived during the pre-trigger period. The extensible constraint policy model and the workload scheduling process can be used together or separately. In conjunction with a scheduler extension, the constraint policy model can be used to augment/replace Kubernetes constraints with constraints that are relevant to edge deployments, including those that pertain to a relationship between Kubernetes endpoints, services, pods, and other extensions such as the Network Service Mesh (NSM).

In various embodiments, the present disclosure includes a method having steps, a workload orchestration system configured to implement the steps, and a non-transitory computer-readable medium including instructions that, when executed, cause a workload orchestration system including at least one processor to perform the steps. The steps include receiving unassigned workloads for assignment on nodes for execution; and, responsive to a scheduling trigger, scheduling the multiple unassigned workloads together considering one or more of resources on the nodes and a constraint policy for each of the unassigned workloads. The workload orchestration system can utilize Kubernetes and the one or more workloads are pods in Kubernetes. The unassigned workloads can include any of new workloads and evicted workloads based on their constraint policy. The scheduling trigger can include expiration of an amount of time where no additional unassigned workloads are received. The constraint policy of at least two of the unassigned workloads can include a shared constraint.

The steps can further include associating the constraint policy to a workload of the unassigned workload being managed by the workload orchestration system; subsequent to the scheduling and implementation of the workload, tracking compliance of the workload to the constraint policy; and, responsive to a violation of the compliance, performing one or more of ignoring the violation, mediating the violation to meet the compliance, and evicting the workload to restart the workload. The constraint policy can include one or more constraint rules. The one or more constraint rules can include at least one network connectivity constraints including any of bandwidth, latency, and jitter. The one or more constraint rules can include a name, a requested value, and a limit value.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of a system illustrating s constraint policy information model and its interactions with model controllers that implement a constraint policy capability as well as its interactions with other entities in a Kubernetes deployment.

FIG. 2 is a diagram of a persistent volume definition.

FIG. 3 is a diagram of a persistent volume chain.

FIG. 4 is a diagram of an example 3 Node Kubernetes cluster.

FIG. 5 is a diagram of a Connectivity Resource Requirement.

FIG. 6 is a diagram of telemetry aware scheduling.

FIG. 7 is a diagram of Actual Connectivity Telemetry.

FIG. 8 is a diagram of pod Eviction and Reschedule based on Connectivity Telemetry.

FIG. 9 is a diagram of scheduling multiple pods simultaneously.

FIG. 10 is a diagram of network element link telemetry capture.

FIG. 11 is a diagram of multiple paths for pods.

FIG. 12 is a diagram of a sample ML Closed Loop Pipeline.

FIG. 13 is a diagram of a Kubernetes cluster with all its components.

FIG. 14 is a diagram of multi-Cluster Scheduling Strategies.

FIG. 15 is a diagram of orchestrating device configuration via Kubernetes CRDs.

FIG. 16 is a diagram of CRD driven chaining.

FIG. 17 is a diagram of enterprise multi-MEC applications.

FIG. 18 is a diagram of a system using Constraint-Base Scheduling with Public Clouds.

FIG. 19 is a diagram of a MEC architecture with a Kubernetes overlay.

FIG. 20 is a diagram of a Kubernetes cluster mesh.

FIG. 21 is a block diagram of a processing system, which may be used to implement various processes described herein

FIG. 22 is a flowchart of a process for a workload orchestration system for extensions to constraint policy and/or scheduling of workloads.

### DETAILED DESCRIPTION OF THE DISCLOSURE

Again, the present disclosure relates to systems and methods for a constraint policy and scheduling for a workload orchestration system, such as Kubernetes. In an embodiment, the present disclosure adds an extensible constraint policy model to a workload orchestration system, such as Kubernetes. In another embodiment, the present disclosure includes a workload (pod) scheduling process that can delay scheduling of workloads until a trigger is detected at which point the workload scheduling is completed (continues) based on a plan derived during the pre-trigger period. The extensible constraint policy model and the workload scheduling process can be used together or separately. In conjunction with a scheduler extension, the constraint policy model can be used to augment/replace Kubernetes constraints with constraints that are relevant to edge deployments, including those that pertain to a relationship between Kubernetes endpoints, services, pods, and other extensions such as the Network Service Mesh (NSM).

With respect to the constraint model, the present disclosure:
Provides a runtime extensible constraint policy model for Kubernetes,
Provides a composable constraint policy model such that policies are defined and managed separately from how they are applied or associated with workloads (pods, deployments, etc.),
Provides a framework for periodic policy rule evaluation and marking of those policies as within compliant, within limits, or in violation,
Provides a framework in which actions, including ignore, mediation, and eviction, can be taken when a policy is in violation,
Enables scheduling of workloads, both at the cluster and multi-cluster level, based on the constraint model, and
Provides a mediation layer to interact with the environment when a constraint cannot be met “as is”, so that the environment may be modified such that the constraint can be met.

With respect to the scheduling process, the present disclosure:
Provides a mechanism to specify a set of pods (“pod set) to be scheduled as a group against a set of nodes,
Provides a mechanism to specify and automate the changing of a trigger (“schedule trigger”) to initiate the placement of a set of pods onto a set of nodes,
Utilizes multiple, competing schedule planners to provide to optimization of the placement of a set of pods across nodes, and
Provides multiple rating (reward) calculations for proposed plans to aid the selection of the optimal plan to place a set of pod on nodes.

### Abbreviations

| | |
|---|---|
| API | application programming interface |
| AR/MR | augmented and mixed reality |
| BSS/OSS | business support system/operations support system |
| CNCF | Cloud Native Computing Foundation |
| CNF | cloud-native network function |
| CNI | container networking interface |
| CRD | custom resource definition |
| DNS | domain name service |
| ETSI | European Telecommunication Standards Institute |
| HTTP | hypertext transfer protocol |
| K8s | Kubernetes |
| L2 | layer 2 networking |
| L3 | layer 3 networking |
| MEC | multi-access edge computing |
| NF | network function |
| NFV | network function virtualization |
| NSM | network service mesh |
| NFVO | network function virtualization orchestration |
| MANO | management and orchestration |
| QOS | quality of service |
| SCTE | Society of Cable Telecommunications Engineers |
| SIG | special interest group |
| SOC | separation of concern |
| VM | virtual machine |
| VNF | virtual network function |
| WAN | wide area network |

### Definitions

| | |
|---|---|
| Mixed | Merging of physical and virtual worlds to produce new |
| Reality | environments and visualizations, where physical and |
| | digital objects co-exist and interact in real time. |
| Augmented | Related to Mixed Reality term, and it takes place in the |
| reality | physical world, with information or objects added virtually. |
| Edge | The delivery of computing capabilities to the logical |
| Computing | extremes of a network in order to improve the |
| | performance, operating cost and reliability of applications |
| | and services. By shortening the distance between devices |
| | and the cloud resources that serve them, and also |
| | reducing network hops, edge computing mitigates the |
| | latency and bandwidth constraints of today's Internet, |
| | ushering in new classes of applications. In practical terms, |
| | this means distributing new resources and software stacks |
| | along the path between today's centralized data centers |
| | and the increasingly large number of devices in the field, |
| | concentrated, in particular, but not exclusively, in close |
| | proximity to the last mile network, on both the |
| | infrastructure and device sides. |
| Edge | Cloud-like capabilities located at the infrastructure edge, |
| Cloud | including from the user perspective access to elastically- |
| | allocated compute, data storage and network resources. |
| | Often operated as a seamless extension of a centralized |
| | public or private cloud, constructed from micro data |
| | centers deployed at the infrastructure edge. Sometimes |
| | referred to as distributed edge cloud. |
| | Implementation of these capabilities with Kubernetes |
| | clusters is an example embodiment. |

### Kubernetes

A workload is an application, service, capability, or a specified amount of work that consumes cloud-based resources (such as computing or memory power). Examples of workloads can include databases, containers, microservices, Virtual Machines (VMs), Hadoop nodes, and the like. Workload orchestration is [symbol] workload orchestration system, focusing on container orchestration. In

[symbol]

The foregoing descriptions are presented with reference to Kubernetes as the workload orchestration system and pods as the workloads, but those of ordinary skill in the art will recognize the various techniques described herein can be used with other workload orchestration systems and workloads.

### Constraint Model Background

When defining pods in Kubernetes, an operator can specify constraints that help determine the placement or scheduling of the pod onto a Kubernetes node (compute host). Kubernetes provides a limited set of constraints including CPU and memory. The constraint definitions are not standalone and are part of the pod definition and thus Kubernetes does not allow shared constraint policy definitions that can be applied to multiple pods. The set of constraints can be extended in a limited way: the constraint context is a single pod, and the value of the resource must be an integer without a unit specification. In short, it is not fully expressive or composable.

Currently Kubernetes has a limited resource constraint model in that they have few pre-defined resource constraints (memory and CPU). Kubernetes allows the addition of custom constraint with considerable restriction on these extensions, i.e., that they must have an integer value and thus cannot be associated with a unit specifier.

Additionally, the existing Kubernetes constraint model requires that the operator specifies the constraints on all pod definitions. This means that Kubernetes, today, does not allow an operator to define a common or shared set of constraints and them apply them to multiple workloads.

Disadvantageously, the current implementation in Kubernetes does not provide of a validation of a constraint setting; thus, it would be possible to either specify:
(1) A constraint does not have a provider (could be a typo or the constraint could not exist),
(2) A limit or request value which is not valid (such as specifying a time 5 ms when the value should be a size 5 MB),
(3) A limit or request value which does not make sense (such as a limit that is more restrictive than a request such as when a requesting disk size and the limit is 2 MB and the request is 1 MB).

Also, the current implementation in Kubernetes does not provide a mechanism to list all the installed resource constraint types.

These limitations can be addressed as follows:
(1) By adding a validation method to the rule provider interface constraint rule specifications can be validated to be “correct” and those that are not correct can be rejected with an error back to the operator. This validation method can essentially be used as an admission controller for request to create or modify ConstraintPolicy instances as part of a constraint policy controller.
(2) This limitation might be addressed several ways. One way would be to simply search for services labeled as providers. This would require no changes to the system but is less convenient for an operator. Another approach is to have a best practice of providers creating an additional CRD instance when they are created. This CRD instance could be something like ConstraintRule and then the operator could list the ConstraintRule instances to understand what constraints are present in the system. These ConstraintRule instances could be verified periodically by a ConstraintRule controller by attempting to locate and to a heartbeat to the provider. If the heartbeat failed, then the ConstraintRule instance might be deleted or marked as non-verified in some way. If we did not want to require a provider to create a ConstraintRule instance both the creation and deletion could be handled automatically via the ConstraintRule controller.

### Constraint Policy Model—Model Objects

ConstraintPolicy—A constraint policy is a set of constraint rules, where each rule can be defined as a tuple of constraint name, constraint request, and constraint limit. From a technical point of view a constraint rule is a unique name associated with a request and limit value (strings). There are not “built in” constraint rules.

Constraint rules are evaluated by a “rule provider”, which is a component that supports the evaluation of one or more constraint rules by supporting a Google Remote Procedure Call (GRPC) interface exposed as a Kubernetes service. A provider is identified by a namespaced label search of the form “connect.ciena.io/provider-<rule-name>: enabled”. If more than a single service contains the label it is non-determinate which service will be invoked. A single service may support multiple rules.

Because rules and their providers are mapped via Kubernetes' labeling system constraint rules can be dynamically added, X-graded, etc. within a deployment. This provides for a truly extensible constraint model.

### Constraint Policy Model—Example 1

In this example, the constraint policy specifies constraints that pertain to the connectivity between resources, e.g., bandwidth, latency, jitter, etc. Each is specified with a request value, the value the operator would prefer, and a limit value, the least acceptable value the operator will tolerate. For example:
apiVersion: constraints.io/v1alpha1
kind: ConstraintPolicy
metadata:
   name: connect-policy
   namespace: default
spec:
   rules:
      name: bandwidth
      request: 20M
      limit: 10M
      name: latency
      request: 500 us
      limit: 50 ms
      name: jitter
      request: 500 us
      limit: 50 ms

### Constraint Policy Model—Example 2

In this example, the constraint policy refers to constraints that are currently supported in Kubernetes to demonstrate how the connect policy can be used as a super set of existing resource constraints. For example:
apiVersion: constraints.io/v1alpha1
kind: ConstraintPolicy
metadata:
   name: compute-policy
   namespace: default
spec:
   rules:
      name: CPU
      request: 4
      limit: 2
      name: memory
      request: 8G
      limit: 4G

### Constraint Policy Model—ConstraintPolicyOffer

The ConstraintOffer is the object in the model that is used to created associations between “targets” and policies. The constraint offer can be a tuple of constraint policies, target selectors, evaluation parameters.

### Constraint Policy Model—Example 3

This example demonstrates an offer that selects two applications (app: client, app: server) as targets and associates them with the connect-policy defined above. Additionally, the eviction policy and timing information for policy evaluation has been set. As indicated in the example's comment, the names associated with targets are not required by the system but may be required by specific rule provider implementations. While this example shows a single policy in the offer, an offer may contain multiple policy references.

It is important to note, that when specifying the targets in a policy offer the apiVersion and kind are used to identify the target type. This allows offers to be specified referencing both core Kubernetes objects as well as CRDs, see example 4. For example:
apiVersion: constraints.io/v1alpha1
kind: ConstraintPolicyOffer
metadata:
   name: connect-offer
   namespace: default
spec:
   targets:
      “name” values for each entry can be either viewed as a form of
      documentation in the case where the rule provider does not use them or
      they could have meaning in the provider's implementation.
      name: source
      apiVersion: v1
      kind: Pod
      labelSelector:
         matchLabels:
         app: client
      name: destination
      apiVersion: v1
      kind: Pod
      labelSelector:
         matchLabels:
         app: server
policies:
   connect-policy
violationPolicy: Evict
period: 5 s
grace: 1 m

### Constraint Policy Model—Example 4

This example demonstrates a policy offer that selects to a CRD, NetworkService, as a target.
apiVersion: constraints.io/v1alpha1
kind: ConstraintPolicyOffer
metadata:
   name: connect-offer-two
   namespace: default
spec:
   targets:
      name: source
      apiVersion: v1
      kind: Pod
      labelSelector:
         matchLabels:
         app: client
      name: destination
      apiVersion: networkservicemesh.io/v1alpha1
      kind: NetworkService
      labelSelector:
         matchLabels:
         chain: security
policies:
   connect-policy
violationPolicy: Evict
period: 5 s
grace: 1 m

### Constraint Policy Model—ConnectPolicyBinding

The constraint policy controller periodically evaluates the ConnectPolicyOffers and based on that evaluation manages a set of ConnectPolcyBinding instances. A ConnectPolicyBinding represents a concrete instantiation of a policy instance against one or more targets and the current evaluation of the rules contained in that policy. As part of the binding its current state is captured in its status along with the details pertain to each rule in the policy binding. The state can be compliant, limit, or violation. These states have the following meaning:
(1) compliant—the current constraint value meets or exceeds the specified request value,
(2) limit—the current constraint value meets or exceeds the specified limit value, but does not meet the request value, and
(3) violation—the current constraint value does not meet the specified limit value.

For an example 5:
apiVersion: constraints.io/v1alpha1
kind: ConnectPolicyBinding
metadata:
   name: gold-offer-5dcc5f56cf
   namespace: default
   labels:
      constraints.ciena.io/connectPolicyOffer: connect-offer
spec:
   offer: connect-offer
   targets:
      name: destination
      id: default:Pod/server-559b94fd68-dgk2q
      name: source
      id: default: Pod/client-f48d4f88d-tfctx
status:
   compliance: Violation
   details:
      compliance: Violation
      policy: gold-policy
      reason: latency-over-limit
      ruleDetails:
         compliance: Compliant
         reason: bandwidth-within-limit
         rule: bandwidth
         compliance: Violation
         reason: latency-over-limit
         rule: latency
         compliance: Compliant
         reason: jitter-within-limit
         rule: jitter
firstReason: latency-over-limit
lastComplianceChange Timestamp: “2021-07-13T23:55:38Z”

### Constraint Policy Information Model and its Interactions With the Model Controllers

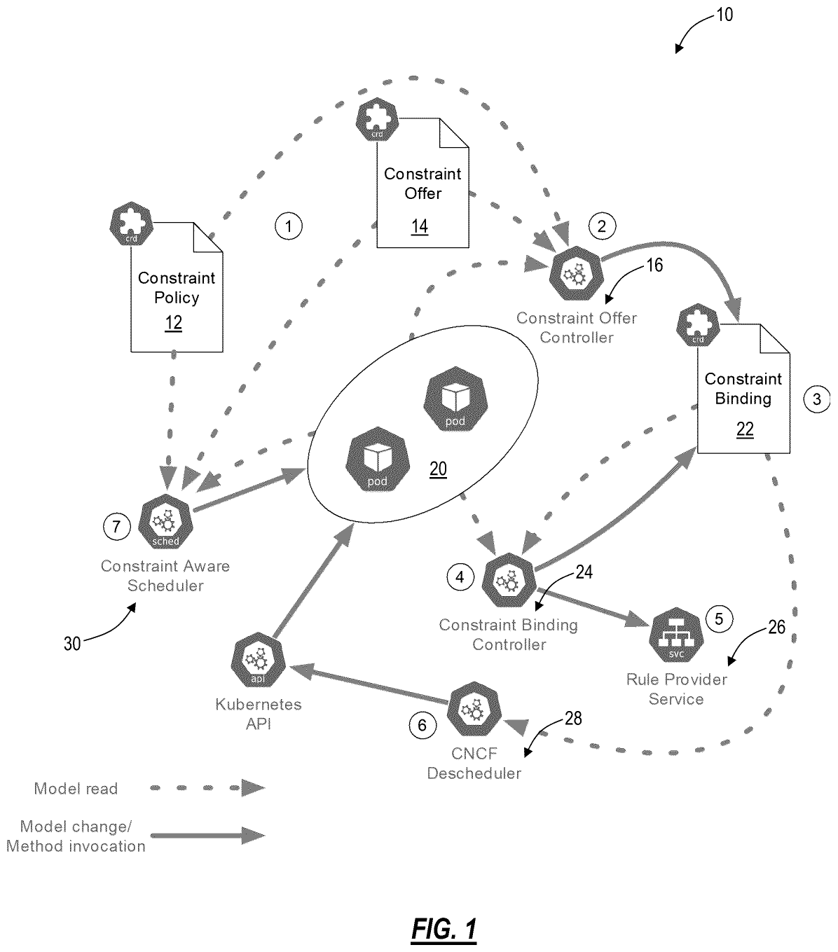

FIG. 1 is a diagram of a system 10 illustrating a constraint policy information model and its interactions with model controllers that implement a constraint policy capability as well as its interactions with other entities in a Kubernetes deployment. A ConstraintPolicy entity 12 and ConstraintOffer entity 14 are defined by an operator (step 1). A ConstraintOffer controller (step 2) uses these entities 12, 14 plus the information available about pods 20 to understand which offers apply to which pods 20 and for each tuple (offer and pod or pods) creates ConstraintPolicyBinding 22 (step 3).

A ConstraintPolicyBinding controller 24 (step 4) periodically evaluates the bindings by evaluating the rules of the associated polices by invoking rule providers via the RuleProviderServices 26 (step 5). The status of the binding is then set into the instance status sub-resource and available to the operator and other entities, such as a CNCF descheduler 28. When invoked the CNCF descheduler 28 (step 6) filters for binding instances that are in violation and takes the configured action, which may include ignoring or mediating the violation or eviction (stop, reschedule, and start) of the pod or pods references by the binding.

To gain the full value of the constraint policy system a constraint policy aware scheduler 30 (step 7) should be installed (specifics described below). This scheduler 30 leverages the ConstraintPolicy and ConstraintOffer entities as well as the already scheduled pods to calculate the optimum placement of a pod based on any relevant constraints.

### Scheduling Process

When a pod is defined in Kubernetes, it is sent to the scheduler 30 to be assigned a node on which to execute. The node selection uses multiple parameters including node resource availability, pod resource constraints, and [anti-]affinity to already scheduled pods (pods assigned to nodes). The result of a call to the scheduler is the assignment of the pod to a node given that a node exists that meets the parameters. As described herein and in Kubernetes, a node may be a virtual or physical machine, depending on the cluster. Each node is managed by the control plane and contains the services necessary to run Pods.

The present disclosure extends scheduling in Kubernetes such that when a pod is sent to the scheduler 30 the following processes is invoked:
(1) Any constraint policy offers that apply to the pod are found. When a policy included in an offer refers to multiple targets, if those targets exist in Kubernetes (are already scheduled pods) then information about these pods are gathered as well.
(2) Each policy included in the policy offer is iterated and the set of rules that apply to the pod are collated and duplicates are eliminated (as it is possible that policies duplicate rules).
(3) Each applicable rule is evaluated against the possible nodes on which the pod might be placed (nodes may have already been filtered out by the Kubernetes system based on taints, [anti-]affinity, etc.).
(4) If a given node placement violates a rule, then that node is eliminated from the candidate list
(5) A cost is calculated for the placement of a pod on a node where the cost is an n-dimensional difference from the actual constraint value compared to the request and limit.
(6) Based on policy a node is selected to assign to the pod and the pod will be created on that node. The policy for node selection based on cost could be best fit (closest to the request value) or worst fit (closest to the limit values). It is possible that no node meets all the constraints and in this case the pod will not be assigned to a node and will remain in a pending state.

### Mediators

It is possible that a constraint provider can provide a ConstraintMediator implementation. Simply put, a mediator is a function that when called can attempt to bring a constraint from a violation state to a limit or compliant state. For example, if the operator defined a constraint of available disk space and the disk space was not available on a node the mediator would be called and could attempt to free disk space to allow the constraint to be met.

Mediators can be activated both during the scheduling phase as well as during the policy evaluation phase. During the scheduling phase, a mediator would be used when no candidate node meets the constraint. In this case, the mediator would be called with a list of possible nodes and the mediator could attempt to bring one or more nodes into compliance. During the evaluation phase, when a pod has already been scheduled and is now in violation of a policy rule. The mediator would be called in an attempt to bring the constraint into the limit range and thus the pod would not have to be rescheduled (evicted) to regain compliance.

Mediators, like RuleProviders, can be per constraint rule and can be located by performing a label search against a service or a headless service.

### Multi-Cluster

While this disclosure has been described in the context of a single Kubernetes cluster it can also be implemented across clusters. To provide this capability, the techniques described herein can be adapted to a multi-cluster implementation. For example, new CRD objects, such as ConstraintClusterOffer and ConstraintClusterBinding can be created. These entities would be used to map workloads (deployments, pod, etc.) to clusters that are members of a federation (such as within a KubeFed deployment). Adapting this disclosure to a multi-cluster environment could not only include supporting “cluster” level constraints but could also include inter-cluster constraints.

### Scheduling

In addition to the constraint model, the present disclosure includes extensions, using standard and supported mechanisms, to the pod scheduling mechanism in Kubernetes, such as to delay scheduling of pods until a trigger is detected at which point the pod scheduling is completed (continues) based on a plan derived during the pre-trigger period.

Currently in Kubernetes pods are scheduled one at a time, only considering pods that are already scheduled and running. This can lead to sub-optimal scheduling when pods are specified with resource constraints. There are no known previous solutions to allow pods to be scheduled considering both already scheduled pods and pods that are not yet scheduled (Pending). One known limitation to the current design is that plans are developed independently, and such do not take into account potential resource utilization of other plans. This means that at the time of a trigger the schedule may not be valid based on a change in resource consumption in the Kubernetes cluster.

### Scheduling Process

When a pod is defined in Kubernetes, it is sent to the scheduler 30 to be assigned a node on which to execute. The node selection uses multiple parameters including node resource availability, pod resource constraints, and [anti-]affinity to already scheduled pods (pods assigned to nodes). The result of a call to the scheduler 30 is the assignment of the pod to a node given that a node exists that meets the parameters.

The present disclosure extends the standard scheduler such that when a pod is sent to the scheduler 30 the following processes is invoked:
(1) the “pod set” to which the given pod belongs is determined. Pod set membership is determined by a standard label applied to the pod specification (i.e., io/planner/pod-set). The pod set is namespaced, so a pod set is determined by a pod search in a namespace for peer pods.
(2) if the scheduling trigger (discussed later) for the pod set has not yet fired (set to Schedule) the scheduler planner (discussed later) is called for the pod-set and the scheduler does not assign the pod to a node. By not assigning the pod to a node the pod is left in a Pending state (un-instantiated), causing it to be re-sent to the scheduler after a configurable wait duration.
(3) if the scheduling trigger for the pod set has been fired (set to Schedule) and the given pod has already been accounted for in the “plan” then the pod is assigned to the node specified by the plan. This causes the pod to be instantiated on the assigned node.
(4) If the scheduling trigger for the pod set has been fired and the given pod is not already in the “plan” then the planner is called and using the results the pod is assigned to a node. This causes the pod to be instantiated on the assigned node.

### Scheduling Trigger

A scheduling trigger is an event that indicates that a pod-set can be moved from a planning state to a scheduling state. It is designed such that new triggers can be defined without a rebuild of the entire system. The base of a scheduling trigger can be a Kubernetes custom resource definition (CRD) named “ScheduleTrigger”. This CRD has a simple structure, e.g.,
apiVersion: io/planner/v1.0.0
kind: Schedule Trigger
metadata:
   namespace: my-namespace
   name: MyTrigger
   labels:
      io/planner/pod-set: my-pod-set
spec:
   state: Planning

The trigger is associated with a pod-set via the common label io/planner/pod-set. When the state value is modified from Planning to Schedule, the trigger is considered fired and pods in the associated set will be assigned to nodes. If a trigger's state is set back to the Planning state from the Schedule state, any new or unscheduled pods in that set will remain in a Pending state and be “planned” until the trigger state is set to Schedule.

A trigger's state can be modified several ways including via manual specification changes via the Kubernetes API or the Kubernetes command line tool (kubectl). Additionally, trigger automation can be implemented as part of the Kubernetes environment. Automatic triggers will modify the state of a trigger based on a condition. For example, included in the initial implementation is the concept of “quiet time” trigger. If a Schedule Trigger is augmented with the label io/planner/quiet-time: <duration> then when no new pod is seen by the system within the specified duration the trigger is set to the state Schedule.
apiVersion: ciena.io/planner/v1.0.0
kind: Schedule Trigger
metadata:
   namespace: my-namespace
   name: MyTrigger
   labels:
      io/planner/pod-set: my-pod-set
      io/planner/quiet-time: 1 m5 s
spec:
   state: Planning

It is important to note that when a pod is labeled to be part of a pod set and no trigger can be found for that pod set, then the default is to consider the trigger to be fired (Schedule state) and the pod will be scheduled. This default is set such that if a trigger is not defined the default Kubernetes behavior is taken. This default can be modified as a configuration option to the scheduler extension.

This trigger mechanism allows additional trigger automation to be incorporated as simple workloads that can be added to Kubernetes using standard mechanisms including jobs or pods.

### Schedule Planner

A schedule planner is an algorithm that evaluates the pods in a pod set, including those already assigned to nodes and those yet to be assigned, and determines an optimized placement for those pods not yet assigned to nodes. The optimized placement of the pods must consider the standard scheduling constraints such as taints, [anti-]affinity, cpu/mem resource, etc. as well as any customer or extended scheduling techniques.

A schedule planner is invoked as a Kubernetes service and located via the labels associated with the service. The service for the planner is located by doing a label search within the namespace for the label io/planner/<pod-set-name>/enable. If that label exists and is set to the value true, then this planner will be invoked against the pod set.

The planner interface is given the namespace and the pod set name which should be planned and calculates a map of pods to nodes.

```
Planner interface example:
syntax = ″proto3″;
package planner;
message SchedulePlanRequest {
  string namespace = 1;
  string podSet = 2;
}
message SchedulePlanResponse {
  map<string, string> assignmetns = 1;
}
service SchedulerPlanner {
  rpc BuildSchedulePlan(SchedulePlanRequest) returns
(SchedulePlanResponse);
}
It is the responsibility of the planner control (the entity that calls the
planner) to create a SchedulePlan CRD based on the results of the
call to the planner.
SchedulePlan example:
apiVersion: ciena.io/planner/v1.0.0
kind: SchedulePlan
metadata:
  namespace: my-namespace
  name: my-pod-set-6c5968c8d7-plkck
  labels:
    io/planner/pod-set: my-pod-set
spec:
  plan:
    - pod: pod-6dd8b76cd-62pbm
      node: node1
    - pod: pod-5bf9fc9544-cpqkc
      node: node1
    - pod: pod-6c5968c8d7-plkck
      node: node2
```

When more than a single planner service is associated with a pod set all planners will be invoked and the results of the planners will be evaluated, and a reward value will be associated with each plan. Reward evaluation of plans is similar to the planner in that one or more evaluation services are discovered via a label search and invoked. The average reward value is calculated and assigned to the plan. The plan with the “best” reward value can be selected and created as a CRD instance as in the example above.

### Realizing a Self Optimizing Fabric With Kubernetes Utilizing the Constraint Model and Scheduling

The following describes a use case of the present disclosure for realizing a Self Optimizing Fabric (SOF). For example, the SOF can be as described in U.S. Pat. No. 11,184,234, issued Nov. 23, 2021, and entitled “Self-optimizing fabric architecture and self-assembling network,” the contents of which are incorporated by reference in their entirety. Generally, a SOF can be defined as some federation of controllers. Each controller provides intelligence for the purpose of providing services, namely compute, storage, sensing, and/or networking resources.

A key aspect of the Self Organizing/Optimizing Fabric (SOF) is the composability and management of compute, storage, and connectivity resources and the scheduling of workloads utilizing those resources. Kubernetes is the de facto industry standard for composability and management of compute and storage resources and for scheduling workloads that utilize those resources and is quickly being adopted by operators for their existing and 5G deployments. By extending Kubernetes to support resource management and allocation of connectivity resources it can provide that base capability required for a SOF realization while also providing a platform on which the other aspects of SOF can be realized (AI/ML, edge compute, telemetry, etc.).

This section presents an architecture/implementation to achieve the SOF goals while minimizing the development of “context” components such as resource managers and schedulers utilizing implementation and concepts already available in the Kubernetes platform.

### Kubernetes Resources Basic Review

Again, as described herein, the term workload is equivalent to the Kubernetes concept of a pod. In Kubernetes, a pod is a set of containers that will be scheduled and executed on a single compute resource. It is possible to define “deployments” of more than a single pod in which case the scheduling of each pod to a compute resource is considered independently.

Node—For the purposes of this document the term “compute resource” is equivalent to the Kubernetes concept of a Node and can be used interchangeably.

Compute Resource Constraints—Kubernetes allows the specification of compute resource requests and limits when defining a pod. This specification takes the form of CPU and memory constraints.

Kubernetes schedules a pod to run on a Node only if the Node has enough CPU and RAM available to satisfy the total CPU and RAM requested by all of the containers in the pod. Also, as a container runs on a Node, Kubernetes does not allow the CPU and RAM consumed by the container to exceed the limits you specify for the container. If a container exceeds its RAM limit, it is terminated. If a container exceeds its CPU limit, it becomes a candidate for having its CPU use throttled.

Storage Resource Constraints—Kubernetes manages storage resources using the concepts of volumes, storage class, persistent volumes, and persistent volume claims. While the specifics are relevant to this document, what is relevant is that when specifying a pod the operator can specify storage constraints including storage size, access, class (i.e., 5Gi, ReadWriteOnce, slow).

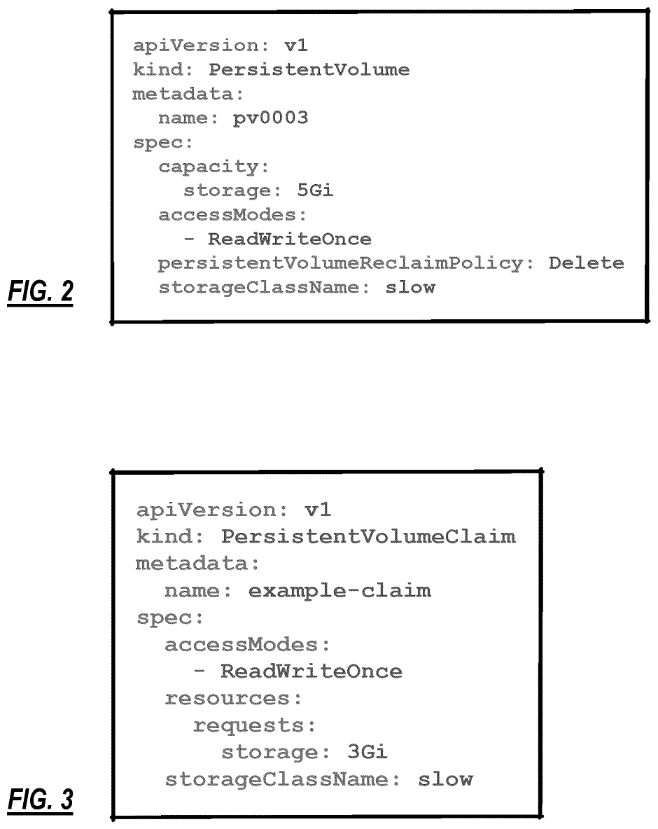

FIG. 2 is a diagram of a persistent volume definition. FIG. 3 is a diagram of a persistent volume claim. The general concept is that an operator can define the available storage capacity and characteristics (FIG. 2) and then a pod can make a “claim” (FIG. 3) storage and Kubernetes will match that claim against the available storage and bind the requested claim to the declared storage. These mechanisms allow the operator to control the storage available to the pods and allows the resources to be managed by Kubernetes.

In addition to specifying constraints related to storage, where the storage is related to a Node Kubernetes additionally allows the use of Node affinity or anti-affinity to influence the scheduling or binding of storage for a [od.

### Connectivity

Kubernetes allows the operator to control aspects of connectivity as a resource. To date this has been primarily focused on security and access. With the introduction of the application service mesh, such as Istio into Kubernetes, the ability to apply traffic management policies has been added to the environments. Application service mesh implementations have also begun including connectivity metric collection and visibility of that data to their implementations. This has not yet evolved to including this information in the scheduling process, but that perhaps is a longer-term goal.

### Kubernetes-Based SOF

The simplistic view of bringing SOF to the Kubernetes environment is the ability to introduce connectivity/network telemetry in the Kubernetes pod scheduling and eviction policies. When extended to the SOF-AI concept this expands to include prediction, based on machine learning, into the scheduling and eviction policies.

### Node to Node Latency

In order to leverage connectivity/network telemetry in the Kubernetes pod scheduling and eviction policies this telemetry must first be collected. In the context of “raw” Kubernetes this might be accomplished via the deployment of a SOF Kubernetes DaemonSet (claim-A). A DaemonSet is a pod that Kubernetes installs on each node in a Kubernetes cluster. As Nodes are added to the cluster a DaemonSet pod instance is scheduled to each node. When a Node is removed the DaemonSet pod instance is terminated.

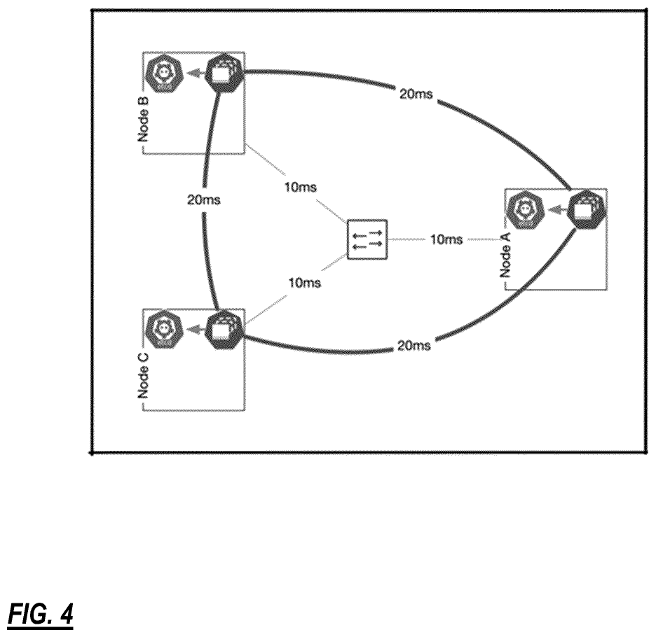

FIG. 4 is a diagram of an example 3 Node Kubernetes cluster. The Nodes A, B, C of this cluster are connected via a single switch and each link has a 10 ms latency. The SOF Daemonset, depicted as a hexagon icon, allows the SOF to deploy a capability to each Kubernetes node automatically. Using the Kubernetes' APIs, the DaemonSet instances can locate each other as well as collect telemetry such as latency and jitter such as via the Internet Control Message Protocol (ICMP) ECHO protocol. This telemetry can be managed via the existing Kubernetes stores (Etcd) or a new storage could be introduced if required. As depicted in FIG. 4, the latency between the Nodes is 20 ms.

### Connectivity Telemetry Aware Scheduler

Once connectivity telemetry is available then it becomes possible to leverage that telemetry when scheduling Pods in the Kubernetes environment. There are two aspects to introducing connectivity telemetry into the Kubernetes scheduler: allowing the constraints to be specified against a pod and augmenting the scheduler to use the information.

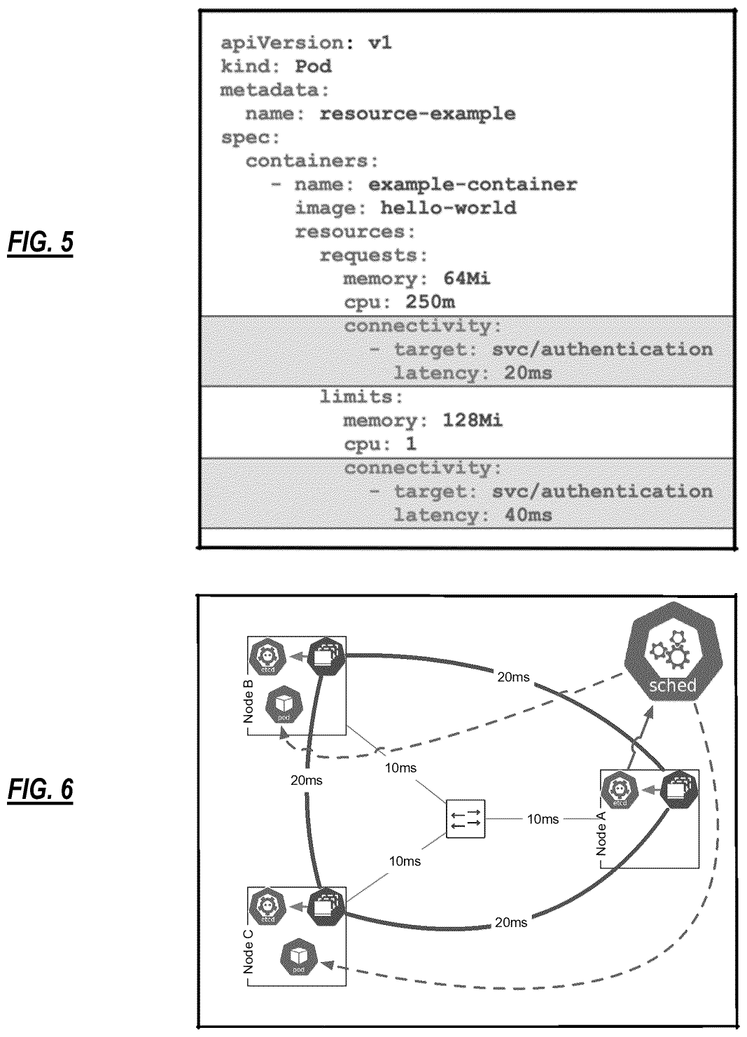

FIG. 5 is a diagram of a Connectivity Resource Requirement. FIG. 6 is a diagram of telemetry aware scheduling. The proposal is to introduce a new resource request and limit value into the manifest for a container as is leveraged by both pod and Deployment specifications (FIG. 5).

It is a goal of this disclosure to be implemented via Kubernetes extension capabilities and not require a “fork” of Kubernetes or its parts. If it is not possible to extend existing Kubernetes manifest schemas without requiring such a fork alternatives mechanisms will be investigated such as introducing a custom Kubernetes resource to support the specification of connectivity constraints.

Connectivity constraints differ from existing constraints as they do not relate to the pod but connectivity between the pod and another pod either directly or through a Service. Through the connectivity constraints a pod can specify the desired (requests) as well as the maximum acceptable (limits) connectivity to each service.

With the constraints as part of a manifest and telemetry being collected by the Daemonset the Kubernetes scheduler can be extended to utilize this information in the initial scheduling of a pod or when a pod has been evicted and needs to be rescheduled.

Telemetry aware schedule is conceptually depicted in FIG. 6 where the Kubernetes scheduler leverages connectivity telemetry to schedule two pod one on Node B and one on Node C. The scheduler for Kubernetes executes on a Kubernetes control plane node which is not explicitly depicted in the figures.

### Connectivity Telemetry Actual

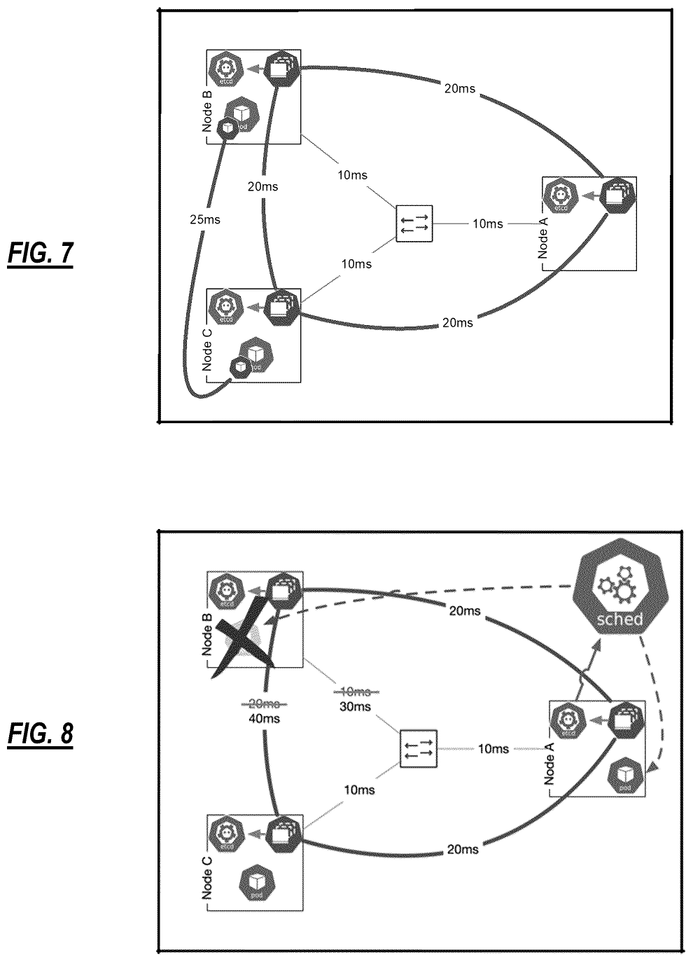

FIG. 7 is a diagram of Actual Connectivity Telemetry. Pods are scheduled based on the connectivity telemetry between nodes as collected by the SOF DeamonSet (SOF-DS). The telemetry collected is expected or predicted telemetry and does not represent the actual connection telemetry between the two pods. It is possible to collect actual inter-Pod telemetry via the existing “side-car” capability of Kubernetes.

A Kubernetes side-car is a container that is automatically deployed in each pod. A networking mesh could leverage this mechanism to instantiate containers with each pod from which actual Pod to Pod telemetry is collected (FIG. 7). As depicted in the figure actual telemetry (25 ms) is different from predicted or Node to Node telemetry (20 ms).

There are four aspects two collecting “actual” telemetry that need to be considered.
(1) Collection and use of “actual” telemetry is optional.
(2) Adding a side-car to each pod increases overall system resource utilization and may negatively impact pod to pod and Node to Node telemetry.
(3) It is unclear if pod to pod telemetry differs significantly from Node to Node telemetry and could make scheduling more difficult. An example would be scheduling pods based on Node to Node telemetry only to find out once the pods are schedule the pod to pod telemetry violates the specified constraints thus forcing pod eviction and causing a potential loop as the pod is re-scheduled based on Node to Node telemetry.
(4) If a service mesh such as Istio is deployed a side-car is already deployed with the Pod. It might be possible to leverage that existing side-car to understand pod to pod telemetry.

### Connectivity Probes, Eviction, and Rescheduling

Kubernetes monitors Pods to determine when a Pod should be evicted (terminated) and rescheduled (claim D). Pod eviction can be carried out for a number of reasons including Pod failure (crash) as well as a violation of resource constraints, such as requesting more memory than the configured limit.

FIG. 8 is a diagram of pod Eviction and Reschedule based on Connectivity Telemetry. It is proposed that Kubernetes is extended to monitor if connectivity constraints are violated, and, if so, use that as a trigger for pod eviction. In the example depicted in FIG. 8, the link between the switch and Node B has increased its latency from 10 ms to 30 ms. The change in the physical link status causes the Node to Node latency to increase to 40 ms and violating a configure latency limit of 30 ms.

Kubernetes could be triggered to validate connectivity constraints either on a configured period as is done with health and liveness probes or evaluation could be triggered on significant data changes, i.e., delta in Node to Node latency values exceeds a threshold. Regardless of how the evaluation is triggered Kubernetes would be extended to detect the violation and use that trigger to determine which pods should be evicted and rescheduled. In the example, FIG. 8, the pod is evicted from Node B and rescheduled on Node A thus restoring the connectivity constraints to a satisfied state.

### Complexity of Scheduling Based on Connectivity Constraints

Scheduling pods based on connectivity constraints adds complexity to the pod scheduling algorithms which are currently single pod focused. For example, when considering the scheduling of a single pod all that needs to be considered is if a given Node can meet the compute and storage constraints of that single pod. The problem is isolated from the scheduling of all other pods.

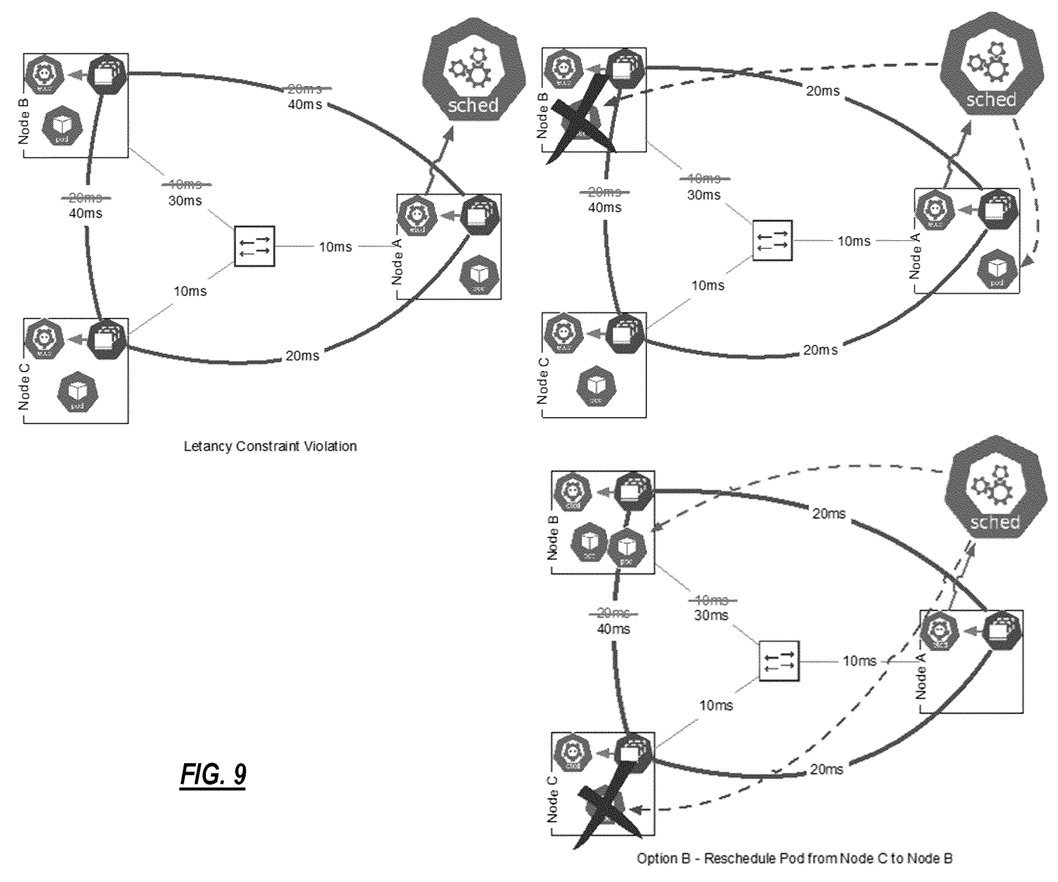

FIG. 9 is a diagram of scheduling multiple pods simultaneously. FIG. 9 is a depiction of possible reschedule options when a constraint is violated. The idea being that multiple changes can be made to bring all pods back into compliance and the system chooses one based on the cost evaluation of the change. When connectivity constraints are considered when scheduling pods, the algorithm must consider the placement of multiple pods simultaneously. Further some of the pods that must be considered when performing the scheduling of a pod might already have been scheduled and executing so the scheduling of a “new” pod might necessitate the eviction and rescheduling of an existing pod.

As depicted in FIG. 9, when a latency violation occurs between the pods on Nodes B and C it can be resolved by either moving the pod from Node B to Node A (Option A in the figure) or by moving the pod from Node C to Node B (Option B in the figure). While this example is not of a new pod being scheduled, similar issues exist with both new pod scheduling as well as rescheduling of pods when constraints are violated.

The complexity of the scheduling increases as connectivity may include multiple pods all dependent on a single pod which provides a “common service” such as authentication. Essentially scheduling when considering constraints that relate to connectivity becomes solving the scheduling problem taking into account a set of pods while optimizing for characteristics including defined resources (CPU, memory, storage, connectivity) constraints while minimizing the amount of change (eviction and/or scheduling) of Pods. Additionally, if some of the deployment are configured for “auto scaling” the algorithm could include scaling (adding or removing) of pods instances to optimize the scheduling of the set of pods.

### Underlay

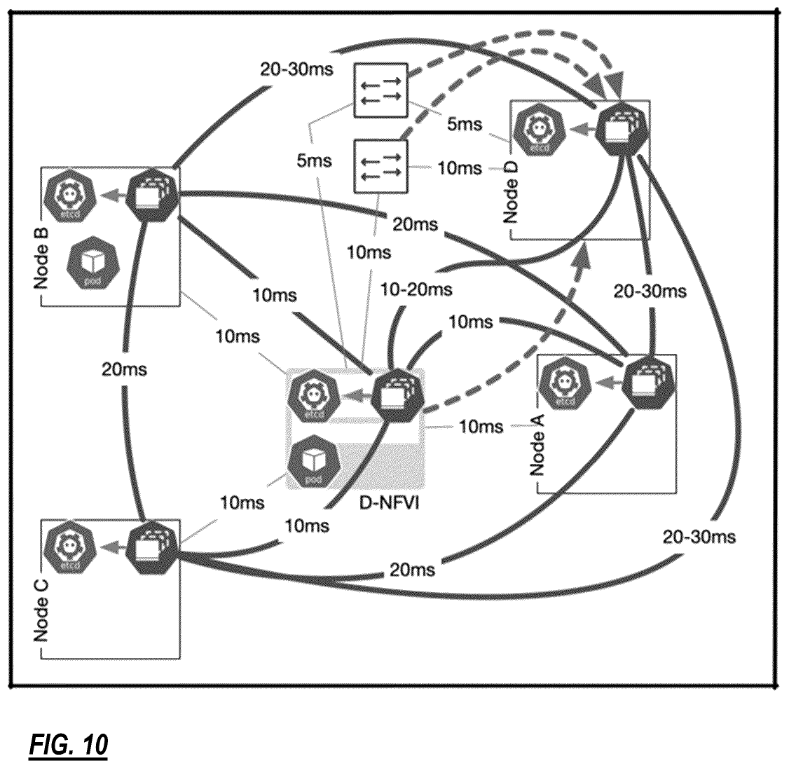

FIG. 10 is a diagram of network element (NE) link telemetry capture. The Kubernetes application networking mesh can include network link level telemetry. There are three main aspects to providing this, the first is the collection of the data, the second is the utilization of that data is pod scheduling, and the third is configuring the underlay to control the data path for pod to pod communication.

As describe above, the networking mesh has the ability to collect Node to Node telemetry via a pod deployed as a DaemonSet on each Kubernetes Node. This telemetry is collected at Layer 3 and is ignorant of the telemetry at the underlay. The collection of NE link telemetry could be accomplished by the DaemonSet instance polling telemetry from the NEs as depicted by the green dashed arrows in FIG. 10. Once this information is collected it is available to the Pod scheduling algorithms and can be leveraged. It is left to a design phase to understand how the DaemonSet instances locate the NEs to monitor as well as how connections are configured (i.e., security, etc.). The only guidance would be that Kubernetes is a declarative environment by nature and in line with that it may be that the most straight-forward approach would be to configure the NEs to be included via a custom Kubernetes resource manifest.

Collection of the NE link telemetry leads to situations where conceptually there are telemetry ranges between any two Kubernetes Nodes (FIG. 10, links marked 20-30 ms) when multiple underlay network paths exist. The pod scheduling would have to be modified to work with components to understand these possible paths and how that might influence the placement of pod on Nodes to meet constraints.

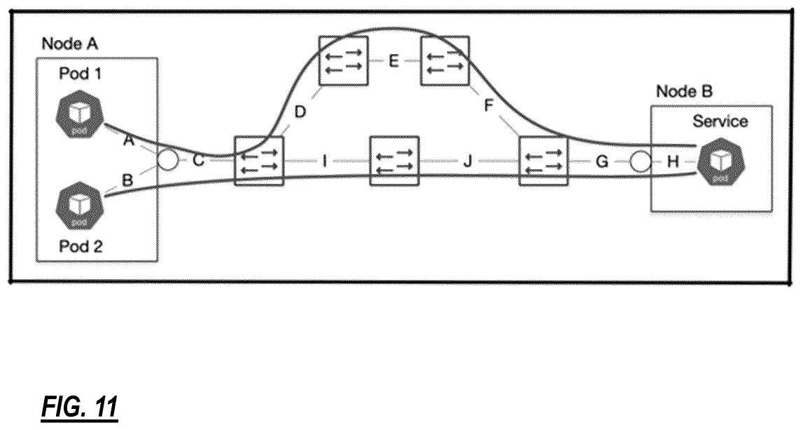

Once the placement of pods and underlay network paths have been selected, the scheduler would need to communicate to the underlay, to provision the selected network path and with standard Kubernetes capabilities to instantiate the pod. Conceptually this capability would allow two pods scheduled on the same Node to communicate to the same pod on a different Node following different underlay paths without affecting the L3 application service mesh provided by Kubernetes. This situation is depicted In FIG. 11, where pod 1 follows path A-C-D-E-F-G-H and pod 2 follows B-C-I-J-G-H.

The networking mesh would continue to monitor connectivity constraints based on Node to Node telemetry and when violated a decision would have to be made in the scheduler to calculate and provision an alternate network path and/or move pods to conform to connectivity constraints.

### Machine Learning

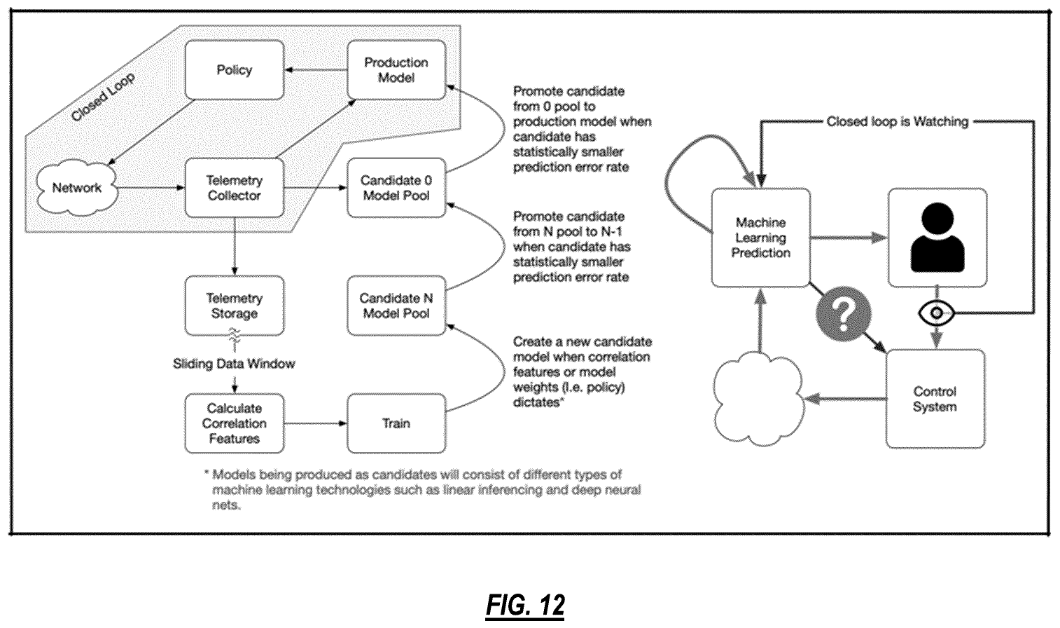

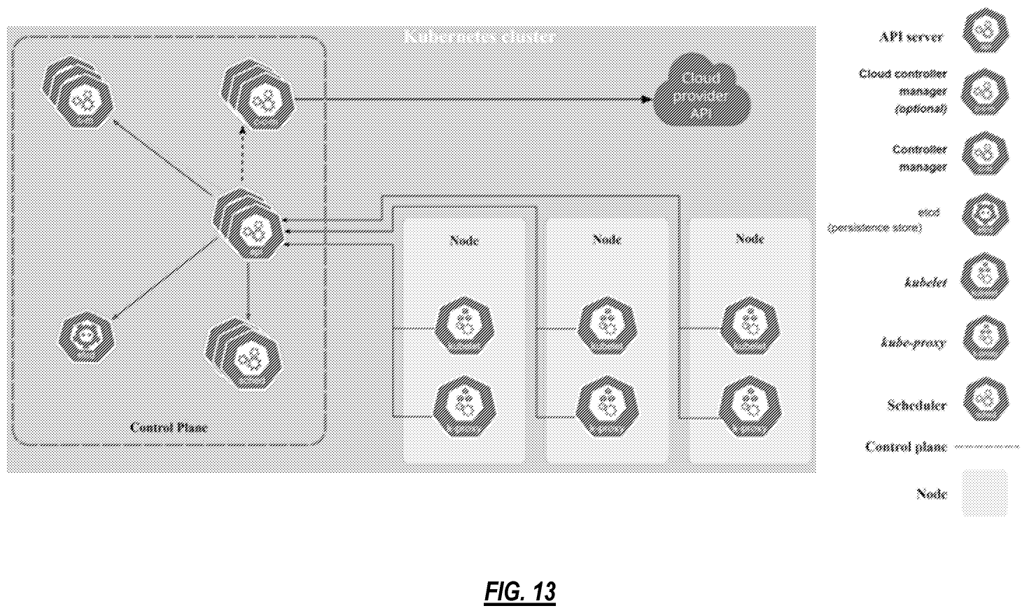

Machine learning (ML) capabilities is not a native part of Kubernetes but can be used to support a SOF concept. Where ML and Kubernetes overlap is the ability to collect data, develop and train ML models, and then utilize those models to influence system behaviors including the (re)scheduling of workloads, the configuration of existing workloads, and the modification of the ML pipelines themselves. The ML capability largely defines the “self-organizing/self-optimizing” aspect of SOF. FIG. 12 is a diagram of a sample ML Closed Loop Pipeline.

From a Kubernetes perspective, the steps of a ML system are workloads or pods that are scheduled across the available resources. As part of the intelligence workflows, or pipelines, are developed to make the ML process consistent and repeatable. Many aspects of ML processing have been implemented within the KubeFlow project from Google and these seamlessly can be integrated into the networking mesh realization by including the require KubeFlow components coupled with custom defined pipelines, model, etc.

By leveraging an existing ML pipeline framework that is already integrated with Kubernetes it allows the development of SOF ML capabilities to proceed focused on building out the required SOF models. Additionally, by leveraging an existing ML pipeline framework the development of SOF models can proceed independently of component development as SOF is realized in Kubernetes.

### Multi-Layer Infrastructure Management for Multi-Access Edge Computing (MEC) Services Using Kubernetes

In another use case, MEC services can be implemented using Kubernetes. Communications networks are at the heart of advancing society and bringing people and places closer together. The evolution of communications services is central in transforming how we work, play, collaborate, and interact with the environment around us. Emerging collaboration technologies such as augmented and mixed reality (AR/MR) promise to offer highly immersive, multi-user, real-time and content rich experiences that will simplify business operations, improve productivity, and unlock new services and revenue sources across a wide range of verticals. This type of application relies on large amounts of bandwidth and extremely low network delay to do real-time processing of very large data sets, tracking user and virtual object movement, while enabling fine-grained interactions between remote users, the physical world, and holographic objects. This will be possible as network application intelligence and cloud platforms converge at the network edge in Multi-Access Edge Computing (MEC) locations.

Over the last decade, communication service providers (CSP) have invested in significant network modernization to keep up with a growing demand for bandwidth hungry applications and increasingly distributed service consumption patterns. The adoption of Telco Cloud architectures for virtualizing network services has improved the operational responsiveness of the network. However, despite advances in network automation, the traditional top-down BSS/OSS operating model has not adapted to the realities of delivering dynamic, cloud-native network services to meet the needs of distributed MEC applications. This new application delivery paradigm requires new operational tools that enable CSPs to maintain carrier-grade operations for virtual machine-based virtual network functions (VNF), while evolving to the on-demand and intent-based deployment of cloud-native containerized workloads for the next generation of network services and MEC applications.

MEC infrastructure and connectivity services are expected to be a growing revenue source for service providers who build a distributed edge compute network platform for application delivery from cloud to edge to the customer premise. However, no single provider will be able to address this massive opportunity, thus, there will be a need to coordinate resources across multiple layers of the network infrastructure as well as the federation of services from different providers in the wide area network (WAN). This type of inter-provider coordination requires the flexibility to define a specific network topology for a given application and user endpoints as well as exposing Telco Edge Operator Platform capabilities. Such a system must include a tighter coupling with application networking for optimal placement of MEC workloads given the specialized requirements for compute resources and proximity to endpoints.

As enterprises adopt hybrid, multi-cloud strategies to support their digital transformation initiatives, pressure is mounting on the traditional telco cloud environment to align with the same level of service agility and developer experience offered by the hyper-scaler cloud providers. This is driving the need to support multiple providers for different components of the application infrastructure. For example, a cloud provider could be responsible for portions of the application infrastructure while a network provider could be responsible for portions of the network infrastructure and latency-constrained application components. Additionally, the use of the same MEC environment to support components from multiple application providers will require different hard or soft isolation techniques at MEC locations. A service provider must also find ways to align to a cloud provider's edge deployment and operations model with suitable hooks for tighter visibility and control of the service provider's network. Service providers will need tools to do this at scale with the likely need to manage 100s-1000s of highly distributed sites.

In this section, a Kubernetes-based control plane is described with built-in intent-driven automation to address these operational challenges and facilitate deployment of both virtual machine based and container based VNFs alongside MEC applications in a hybrid, multi-cloud architecture with a multi-layer connectivity network underlay.

This section first describes the use of Kubernetes technologies and extensions to those technologies introduced as a solution to address the operational challenges implementing a MEC architecture. These technologies are then applied for deploying a MEC architecture based on the Kubernetes system.

### Background and Technologies

The European Telecommunications Standards Institute (ETSI) provides a reference architecture for the deployment of MEC hosts and applications. With the shift to containerized workloads in a cloud-native environment, ETSI work supports the use of container management systems such as Kubernetes for providing platform-as-a-service (PaaS) services. Additionally, the mapping of the ETSI management and orchestration (MANO) information model to the container workload deployment model enables an approach for implementation using a Kubernetes model. The MEC architecture can be deployed using a Kubernetes model and, with extensions, a more complete MEC model can be achieved with virtual machines (VM), VM to container service chaining, and constraint policy based connectivity.

ETSI [Section 8 of reference 1] defines MEC service as a service provided and consumed either by the MEC platform or a MEC application. In the context of this disclosure, the term is inter-changeably used for both user application services, e.g., a MEC application like AR/VR rendering, as well as host or platform services, e.g., traffic management service or domain network service. Note that, as example, some host level MEC services could be offered by a network provider while some application level MEC services could be offered by a cloud provider. Some of these MEC services may be part of the Kubernetes implementation.

### Kubernetes In Brief

Kubernetes is a portable, extensible, open-source platform for managing containerized workloads and services, that facilitates declarative configuration and automation. It has a large, rapidly growing ecosystem. It provides a framework to run distributed systems resiliently, providing standard patterns for application deployment, scaling, failover, security, and load balancing.

Since Kubernetes primarily operates at the container level rather than at the hardware level, it provides some general features common to PaaS offerings, such as deployment, scaling, load balancing, and lets users integrate their logging, monitoring, and alerting solutions. There are also extensions to Kubernetes that allow it to manage VM based workloads as will be discussed later in this section of the document.

Kubernetes is not monolithic, and its default solutions are optional and pluggable. It provides the building blocks for building platforms but preserves user choice and flexibility where it is important.

A single Kubernetes deployment is known as a cluster and consists of a set of machines (physical or virtual) called nodes, which are utilized to host containerized applications. The nodes within a cluster can be classified as either a control-plane node, on which the workloads that implement the Kubernetes system are executed, or a worker node, on which primarily application workloads deployed to the cluster are executed.

The Kubernetes control plane manages the worker nodes and the pods in the cluster, and it makes global decisions about the use of cluster resources. A Kubernetes pod is a schedulable entity that may comprise of one or more containers. The control plane components can be run on any machine in the cluster; however, the usual practice is to run all control plane components on the same machine and avoid running user containers on the same machine.

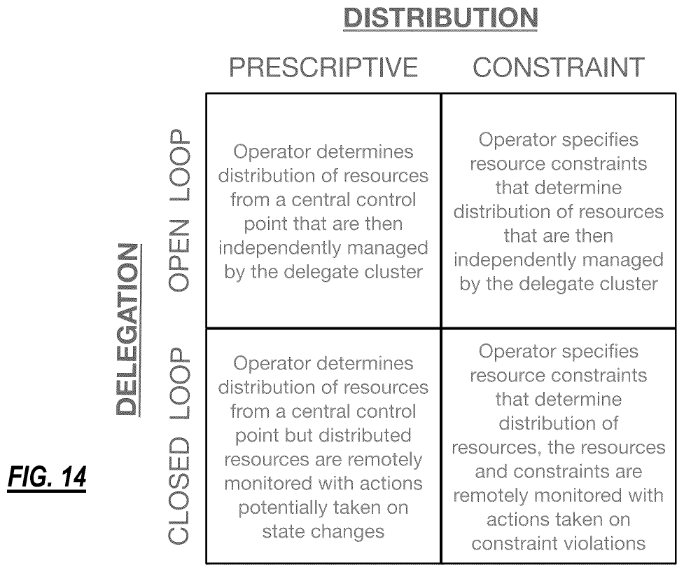

FIG. 13 is a diagram of a Kubernetes cluster with all its components. As mentioned, Kubernetes is an extensible system and a key mechanism to extending Kubernetes is by implementing a custom resource definition (CRD). A resource created through this feature can be used to store and manipulate information in the Kubernetes system. These custom resources are normally used in combination with a custom Kubernetes controller that interprets the data for the custom resource type contained in the Kubernetes store and then reacts to changes in the data (adds, deletes, modifications). This extensibility via CRDs highlights the fact that at its core Kubernetes is a declarative based resource management system and this can be leveraged when implementing a MEC architecture with Kubernetes.

### Multi-Cluster Strategies

Enterprises are adopting Kubernetes as a platform to enable application portability and agile deployment across public clouds, private environments, and more importantly on the network edge to optimize local service performance. This is critical for enterprises running retail, hospitality, and manufacturing operations with 100's if not 1000's of locations where application infrastructure is needed to support B2C and B2B applications.

Kubernetes supports mechanisms such as pods and name spaces to isolate application components, and ensure resources are allocated optimally within a multi-tenant edge cluster. However, as Enterprise MEC applications proliferate at the network edge, industry trends are starting to emerge to define mechanisms to spread workloads across multiple clusters in different geographic areas. The chief technical reasons for multi-cluster deployments are:
Lower latency by deploying applications closer to end users.
Service availability with fail-over support and geo-redundancy
Workload scalability across distinct physical clusters with specialized resources.
Workload isolation & security with physical separation.

The main two dimensions of these multi-cluster trends are the distribution of an application's resources and the delegation of lifecycle control of the distributed application resources, (see FIG. 14).

Distribution of an application's resources refers to how an operator specifies the initial distribution of the resources across the available clusters. Distribution may also reference how an application's resources are redistributed based on a failure or other event. In a prescriptive system the operator specifies the cardinality and location (Kubernetes cluster) for each application resource. In a constraint-based system the operator specifies the constraints for application resources, such as CPU, memory, network bandwidth, and network latency to an internal application resource or another external MEC application. These constraints are used by a scheduler to determine the optimum placement of the application resources.

Delegation of application resource lifecycle control refers to how the lifecycle of a resource is managed, including initial assignment to a member cluster, and any reassignment to a different cluster based on manual intervention or an event. In an open-loop system once a resource is delegated to a participating cluster the resource's lifecycle is completely managed by that cluster and will never be removed from that cluster except via an explicit action. In a closed-loop system, once the resource is delegated to a participating cluster a feedback loop is used to monitor the resource and decisions about moving a resource would be based on a defined policy.

Both the distribution and delegation dimensions reflect the level of automation in a multi-cluster system. Systems that fall to the lower right quadrant (see FIG. 14) tend to be more autonomous where systems that fall to the upper left quadrant tend to be configuration systems that strictly enact actions in the exact way the operator specifies without any remediation based on failures or resources violations.

### Node/Cluster Capability Discovery

Applications are increasingly looking to leverage available hardware accelerators (Graphic Processing Units (GPUs), Tensor Processing Units (TPUs), etc.) and software data plane technologies (Data Plane Development Kit (DPDK), Vector Processing Plane (VPP), etc.) to meet their performance requirements. This information is useful to a MEC control plane when placing MEC service components on inter-connected compute nodes. Leveraging Kubernetes and CNCF projects enables the deployment to self-discover a node's capabilities and report or expose those capabilities to a control-plane to be used during scheduling of workloads. Specifically, the CNCF node feature discovery project provides this capability by discovering node features and labeling nodes in a standard format to allow features to be used as part of the standard Kubernetes scheduling capability. This is of critical importance in space & power constrained MEC environments, where full visibility of resource capabilities and programmability of the network infrastructure enable optimal allocation of premium resources.

### Constraint Policy

Kubernetes provides a mechanism for a workload to specify resource constraints that can be used by the control-plane to influence the node selected when scheduling a workload. The existing mechanism is simplistic and predefines only the CPU and memory resource. Kubernetes does allow for other resources to be defined but limits the requested value of those resources to be an integer without a unit specification.

### Network Connectivity Constraints

Utilizing the constraint policy capability, this implementation defines a set of network connectivity-based constraint providers: bandwidth, latency, and jitter. Using these constraints an operator can specify the requirements for connectivity between two or more workloads. As described herein with respect to network connectivity constraints, bandwidth, latency, and jitter are examples. The present disclosure is not limited to network constraints or these examples. The system is designed to allow the definition of any constraints and be extensible at runtime. For example, one could define a “zone” constraint that is only compliant if the two workloads (pods) on which it is defined are not in the same failure zone. The point being the idea is not limited to network constraints nor the examples of bandwidth, latency, and jitter.

By implementing a declarative model for connectivity within Kubernetes, the network becomes part of the overall resource model within the environment opening new automation use cases, including the ability to declaratively specify constraints that affect the underlay and overlay networks to meet the operator specified application requirements.

### Scheduling Optimization

Again, by default, the scheduling context for Kubernetes is a single pod. During scheduling, Kubernetes selects a node and assigns the pod to that node. Once a pod is assigned to a node the containers defined within the pod are created and invoked. This can lead to sub-optimal scheduling when constraint policies represent a binding between two or more pods as is the case with a connectivity constraint. For optimum scheduling, the entire set of connected pods to be scheduled should be known and a “plan” should be created such that the pods can be scheduled according to the optimized plan.

To provide this capability, a scheduler extension is described herein that operates as an optimized schedule plan builder as well as a gating function to prevent pods from being scheduled until a trigger is detected. For an example implementation, we are using a “quiet” timer, but this is easily extendable to support additional trigger types. The quiet timer simply fires when no new pods are defined over a specified period, thus the assumption being that all required pods have been defined and an optimal schedule can be produced.

Before the trigger fires the scheduler is called repeatedly for each pod. When the planner is invoked, it queries the list of all unscheduled pods and creates a candidate plan, utilizing any specified constraints via the constraint policy resources. If the candidate plan is preferred over the existing plan, the existing plan is replaced by the candidate. In either case, an empty node list is returned indicating to Kubernetes that the pod cannot be placed at this time and the pod will remain in a “Pending” (non-assigned) state. After the trigger fires and the scheduler is called, the scheduler uses the plan to determine the node to which to assign the pod. As pods are assigned to nodes they will be instantiated, and their containers be created. At this time the connect-based constraint policy bindings will be created based on the scheduled pods.

### Network Controller

As described in previous section, the scheduler extension developed as part of this work can leverage the connect-based constraints when scheduling workloads. During development of the solution, it was noticed that under certain conditions the connect-based constraints could not be met by the existing network configuration causing workloads to never be scheduled even if the underlying network had the capacity to meet those constraints.

To accommodate these situations, the concept of a network controller was introduced into the system. A network controller was represented by a defined interface that could be used by the scheduler to request network resources when the current network configuration could not meet the specified constraints. From the perspective of the scheduler, the network controller is an external entity located by a label on the Kubernetes service resource. The network controller as originally conceived eventually became known as a mediator as described previously in this document. In the context here, it is an example of a mediator specific to network level resource constraints.

When invoked, the network controller has the flexibility to modify the underlay and/or overlay network, how it chooses to meet the request and return to the system enough information so that the pods that will be created can leverage the modified resources. This information can be used with network service mesh project to ensure the connectivity to containers by creating the proper network interfaces and configuration on the containers. When the existing network does not meet the constraints and the network controller is not able to modify the network to meet the constraints, the pods will remain in the pending state until the constraints are modified, or the network comes into compliance.

The network controller was then integrated into the de-scheduler capability. When a connect-based constraint was found to be out of compliance, rather than immediately evicting the pod for rescheduling, a capability was added to the network controller to mediate this situation via network configuration. If the network controller is not able to bring the network back into compliance, then based on policy, pods may be evicted to be rescheduled or the violation can be ignored to prevent service disruption.

### Common Application Function Model

Telco cloud implementations based on the ETSI network function virtualization (NFV) model have been in production for several years, delivering data and control plane network functions in a much more flexible and software-based format. These virtual machine-based VNFs evolved from the software applications delivered via dedicated hardware appliances for traditional switching, routing, firewall, and signaling services, among others. From a compute environment perspective, these network applications are no different than enterprise or consumer type applications that are delivered from cloud-native environments today, except for requiring specialized hardware assist for packet processing functions. These functions include protocol encapsulation and decapsulation, packet header classification, inspection and manipulation, wire-speed forwarding, encryption, and traffic protection, to name a few. These functions typically require traffic to be steered through multiple functional blocks that make up a network application service chain. The implication is that it is possible to describe a common model for service function chaining of network application components independently of the specific software logic running within these components. This service function chaining specifies the communication patterns and processing policy for function chaining blocks.

### Service Function Chaining

A network function is composed of one or more deployable components. These components can be inter-connected workloads to provide the overall features intended by the network service. The workloads form a chain with traffic flow sequence dependencies, and therefore, should be deployed as a unit on a single compute cluster node for optimal performance. In a hybrid virtualization configuration, a network function could potentially inter-connect hypervisor and container-based workloads on the same cluster node. For this reason, the MEC compliant platform should expose a common network function model to onboard and chain different workload formats.

Although sub-optimal, there may be cases where service function chains span multiple nodes within the same cluster or even multiple clusters separated by an edge network. This may result from constraints imposed on the service chain and the availability of specialized resources such as GPU or smart Network Interface Controllers (NICs) required to support hardware accelerated functions. In such cases, constraints such as network latency, bandwidth, packet delivery guarantees, and traffic balancing must be taken into consideration when composing the end-to-end service chain through cluster federation mechanisms and network connectivity constraint policy.

### Kubernetes Controllers for Function Chaining

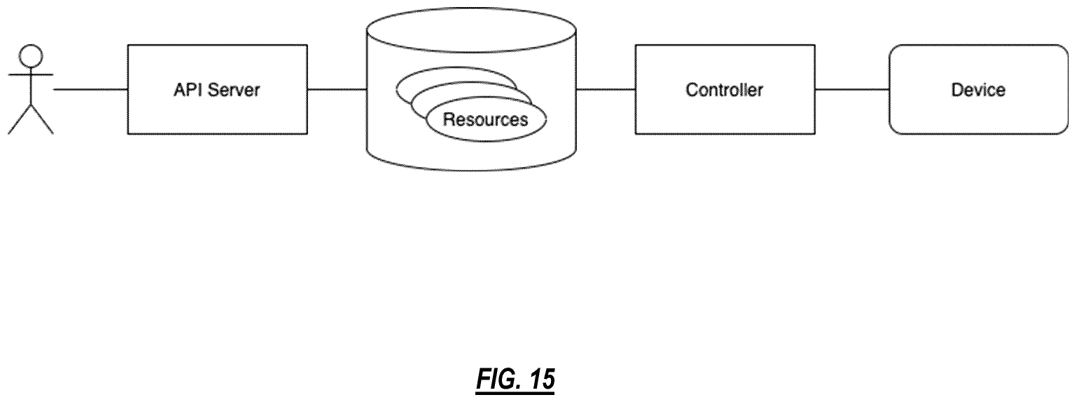

When a purpose-built device and associated objects that consume compute resources are not directly modeled by Kubernetes, they can be represented through CRDs and the Kubernetes API can be extended to expose the configuration and capabilities of that new device. A custom controller can then be implemented to manage the lifecycle and translate the resource data into instructions that the target device may understand. Once CRDs and controllers are installed in a Kubernetes cluster, the orchestration of the device can be done through the Kubernetes control plane by abstracting the interactions through the custom device controller. FIG. 15 is a diagram of orchestrating device configuration via Kubernetes CRDs.

We used this approach to support the orchestration of VM-based and container-based network functions (NF) on a common operational platform and service chained on a common network layer. This common orchestration framework was achieved by defining models to abstract the network function and chaining complexity. The models are then converted to Kubernetes custom resources with their corresponding controllers. The NF controllers are responsible for orchestrating a VM or container, based on the specified NF type. The chaining controller can instruct the cluster to establish connectivity between the NFs on the underlying data plane, which may consist of software-based switching and hardware-based traffic processing.

This orchestration walkthrough for VMs and containers is a simplified and high-level view of what really needs to occur. Two scenarios can be considered to configure a system that supports virtualization for both VMs and containers.
(1) System with hypervisor engine only with a VM instance running container native constructs, such as Kubernetes, to host containers.
(2) System with both hypervisor and container engines to host VMs.

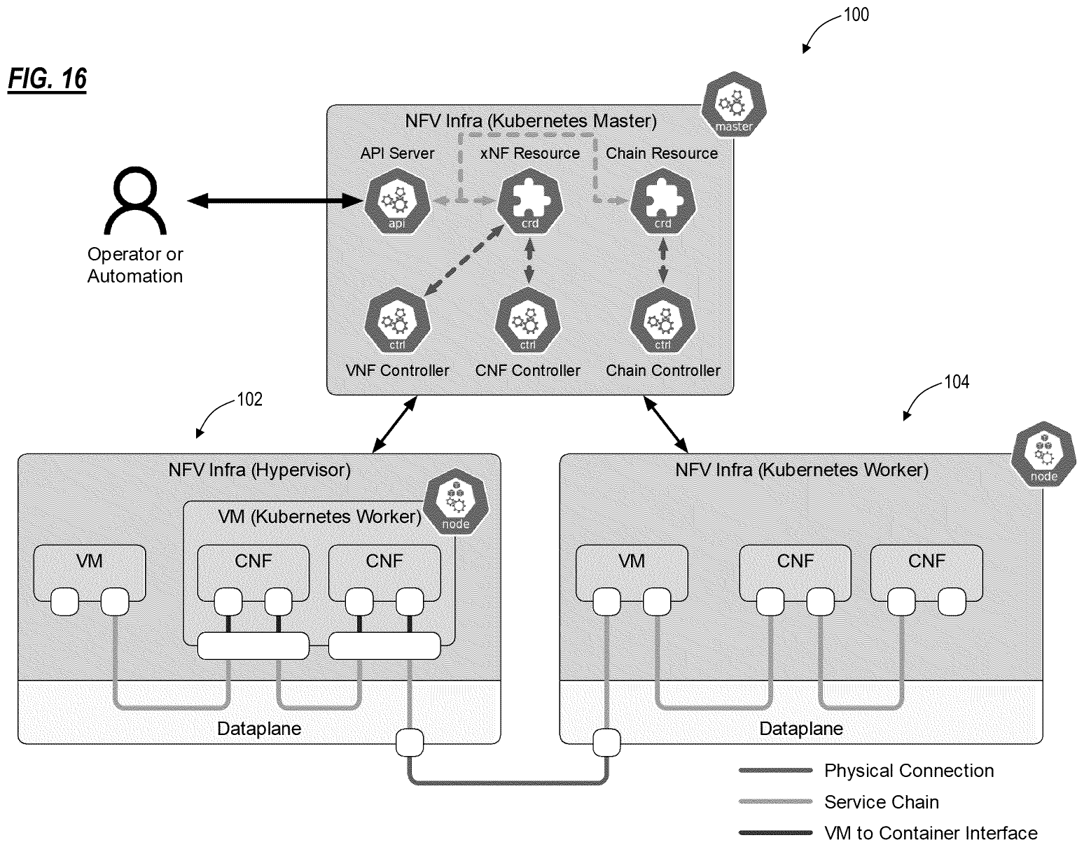

FIG. 16 is a diagram of a system 100 for CRD driven chaining.

In the first scenario, VMs are orchestrated through the system's hypervisor 102. A VM running Kubernetes is also used to deploy the container-based network functions. The connectivity between network functions is handled by service chaining the interfaces allocated to the VMs and then linking the containers with the Kubernetes VM interfaces using container networking interface (CNI) plug-ins (for example, Multus). In the second scenario, VMs and containers are orchestrated by their respective virtualization engines. The connectivity between the network functions is handled by service chaining the interfaces allocated to the VM and containers. In both cases, the interface allocation is provided by the data plane embedded in the NFV infrastructure.

In the second scenario, a VM/Kubernetes capable infrastructure 104 is used to create both the VMs and the containers. The connectivity between the network functions handled by using the infrastructure interfaces to chain the VM interfaces across the data-plane and then into the container-based NFs.

### Public/Private Cloud Integration

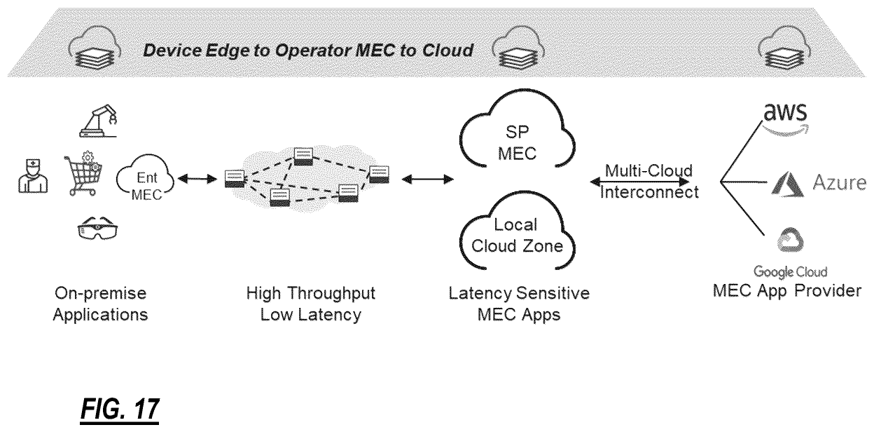

When architecting a multi-cluster Kubernetes deployment, it is important to understand common industry deployment models. Currently, it is common that network operators and enterprises leverage both their private cloud resources and resources available from cloud hyper-scalers such as Google, Amazon, and Microsoft. Consider a scenario where an Enterprise customer with a large chain of retail stores is planning the introduction of new cloud native applications for inventory management, store security, advertising, and in-store customer engagement. This customer uses one of the major cloud providers to run their own DevOps environment and a national network operator to inter-connect all their stores to MEC locations, private data centers and cloud. A key requirement for the Enterprise IT operations team is to unify the management and delivery of containerized applications to 100's of locations (premise and edge) while maintaining a common network and security policy nationally. FIG. 17 is a diagram of enterprise multi-MEC applications that leads to designing a fabric of Kubernetes clusters deployed at many locations, managed through a cloud provider's control plane and interconnected by a network operator that hosts some of the clusters within the MEC locations.

While the capabilities described in the sections above can be deployed into Kubernetes clusters under the administrative control of the network operator, it is not always possible to deploy these capabilities on the Kubernetes clusters provided by the hyper-scalers. This is more obvious when it comes to the aggregation or federated level as each hyper-scaler typically provides a custom federation solution as one of multiple tightly integrated cloud-based services, i.e., Google Anthos, Amazon EKS, Microsoft Arc, Rancher, etc.

How these capabilities can be integrated with the various hyper-scalers' offering depends on the amount of customization each allows. In the case where a custom scheduler extension cannot be deployed, this can be “worked-around” by creatively assigning node affinity to resources before allowing the hyper-scalers scheduler to be activated. Node affinity is a standard Kubernetes capability available on all distributions.

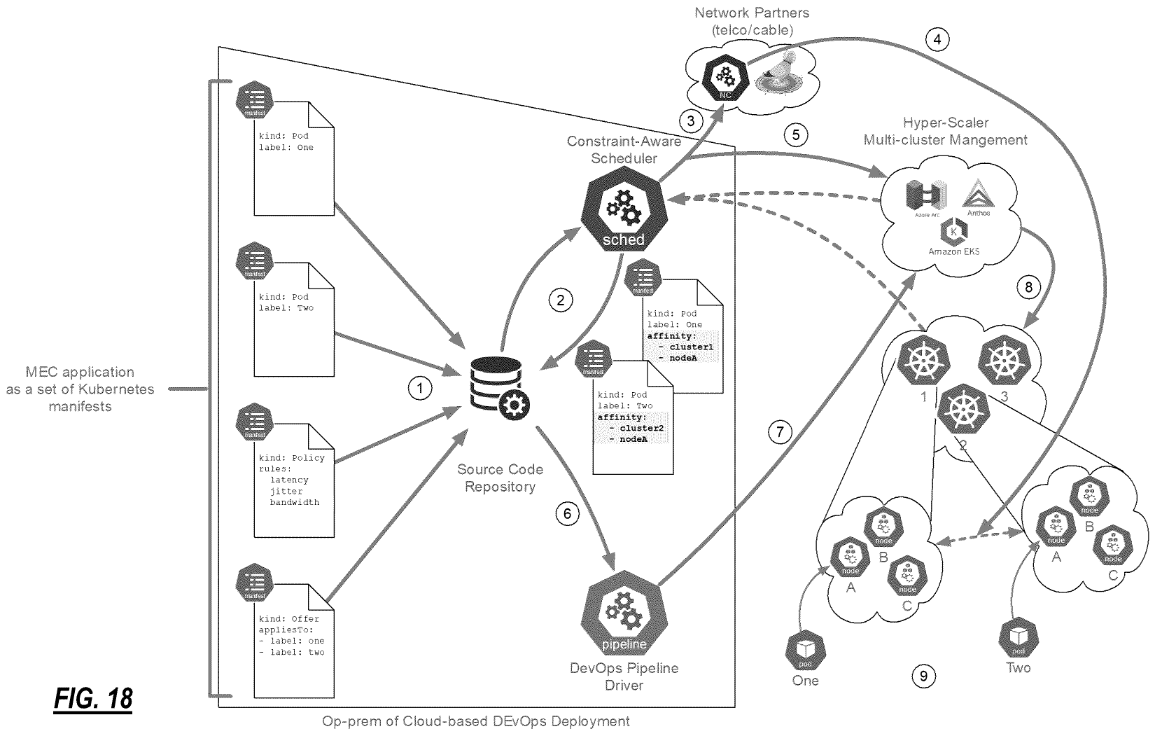

FIG. 18 is a diagram of a system using Constraint-Base Scheduling with Public Clouds. This can be implemented by shifting the capabilities described above, particularly scheduling and descheduling, from the Kubernetes domain to a DevOps domain, as depicted in FIG. 18. In this situation, the DevOps pipeline would be leveraged such that when an application is pushed to storage (step 1), the pipeline would evaluate the scheduling needs of the workload and augment the resources with the node assignment encoded as a node affinity configuration (step 2). Additionally, the constraint aware scheduler may, depending on availability, contact a network controller provided by the network provider (step 3) to request network capabilities compliant with the constraints specified in the constraint policy. This in turn might trigger the network provider to reconfigure the underlay network (step 4). If a network controller is provided by the hyper-scaler, then the scheduler may also make request via that interface which could affect both the overlay and underlay (step 5). After the scheduler updates the manifests and commits those back to storage, the DevOps pipeline receives the augmented manifests (step 6) and pushes the manifests to the hyper-scaler managers (step 7). The hyper-scaler managers process the manifests using their standard schedulers (step 8), adhering to the standard affinity rules, and enact the set node assignment (step 9).

Other than the scheduler extension, the described technologies should be able to be leveraged within a hyper-scaler's environment as the other technologies either are common user-based extensions (CRDs+controllers) or components that run outside the core Kubernetes control-plane (descheduler). The one exception is the network controller, and this may require support from the hyper-scalers to support underlay control; although it is possible to implement a network controller that only affects the overlay.

### MEC Architecture on Kubernetes

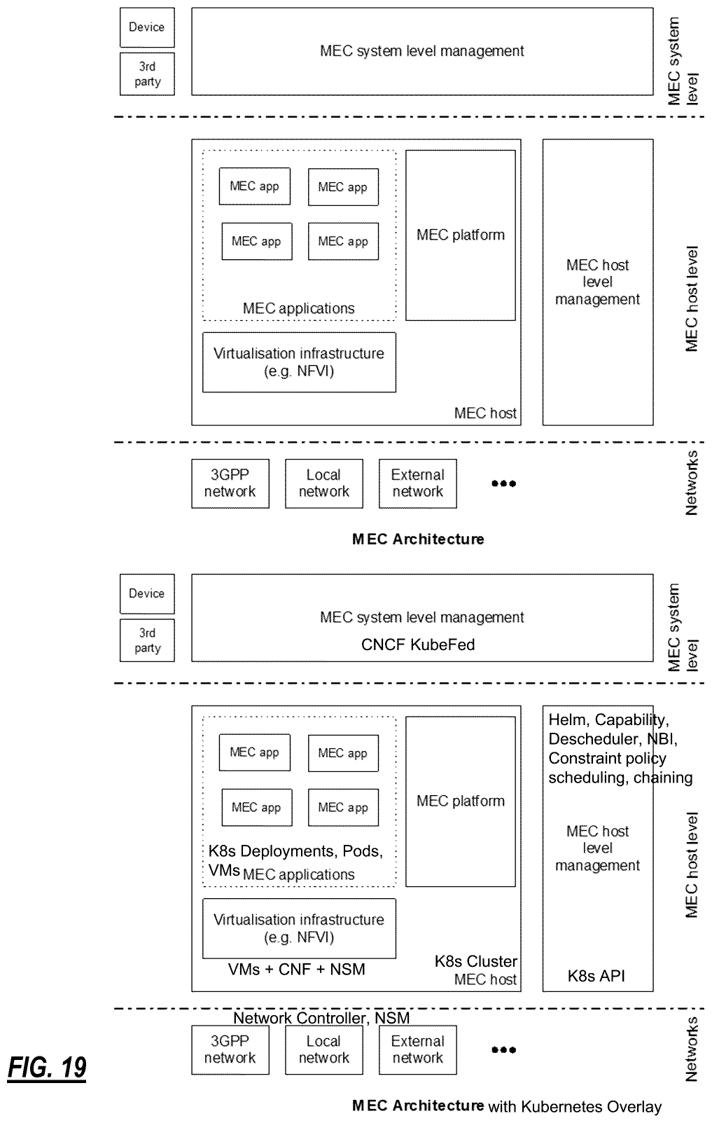

In this section, we describe how the MEC architecture can be implemented using the de facto industry standard container orchestration system originally developed by Google, i.e., Kubernetes. FIG. 19 is a diagram of a MEC architecture with a Kubernetes overlay. Specifically, FIG. 19 depicts the standard MEC architecture on the left and on the right depicts that same architecture with an overlay that indicates the cloud native technologies that can be leveraged to implement the MEC architecture. The following sections will detail how each component of the MEC architecture can be implemented using specific cloud native technologies.

### MEC Host

A MEC host is defined as “an entity that contains the MEC platform and a Virtualisation infrastructure which provides compute, storage and network resources for the MEC applications. The Virtualisation infrastructure includes a data plane that executes the traffic rules received by the MEC platform and routes the traffic among applications, services, Domain Name System (DNS) server/proxy, 3GPP network, other access networks, local networks and external networks.” By this definition the MEC Host is functionally equivalent to a Kubernetes cluster, which is defined as “A set of worker machines, called nodes, that run containerized applications.” The Kubernetes cluster provides the virtualisation infrastructure and data plane as required by the MEC definition. While Kubernetes' original focus was orchestration of containers, several virtualizations extentions have been added to Kubernetes to provide a run-time for virtual machines and networking.

### MEC Virtualization Infrastructure

The virtualization infrastructure of a MEC compliant system should have the ability to orchestrate hybrid service deployments where VMs and containers can coexist on the same platform. To achieve this hybrid configuration, there is a need to accommodate VM based network functions within Kubernetes. A system with such capabilities would have to share resources (compute, memory, storage, networking) to offer a seamless integration with the hosting platform. KubeVirt is one of several projects of the Kubernetes ecosystem that can manage the lifecycle of virtual machines within a Kubernetes cluster while also supporting container workloads.

Additional solutions and platforms exist that provide VM/container capability through the Kubernetes declarative model solution. Further, some of these solutions provide a tight integration with the network interfaces such that they are purpose built to support VM and container-based network functions.

Today the declarative models used to define VM based resources vary across the available solutions and most focus primarily on the detailed attributes for creating a VM and less on the concept of chaining NFs. The solution described herein bridges this gap by allowing the specification of network services that can contain both VMs and container-based NFs, abstracting away the specific virtualization choice and focusing on the connectivity between those functions. Further, this approach can be extended in the future to support additional virtualization techniques and/or new infrastructure as it is released by vendors.

### MEC Applications

A MEC application “runs a virtualized application . . . on the infrastructure provided by the MEC host.” Within Kubernetes the typical executable workload is known as a pod, which is a set of containers run on a single Kubernetes node that share storage and networking. As shown above, with the use of CRDs, Kubernetes can be extended such that a workload may be either a pod (container) or a VM.

Kubernetes provides several “higher” level resources constructs that help the operator group and deploy the basic building blocks of an application. These include a Deployment, which is a set of distinct pod definitions and the cardinality for each of the pod types, as well as a ReplicaSet, which maintains a stable set of pod instances for a single pod definition. In addition to pods and other deployment constructs Kubernetes also provides mechanism to enable load-balancing and high availability for applications.

These basic building blocks provided by Kubernetes provides the basis on which MEC compliant applications can be built. Because an application typically requires more than a single Kubernetes resource, a higher-level application construct can be created using the CNCF Helm tool. This abstraction allows a MEC application developer to specify any number of Kubernetes resources as a set and then deploys that set of resources under a single name, thus allowing a complete application to be deployed instead of dealing with the applications piecemeal.

At its core. Helm is a template engine that create instances of resources based on defined templates, parameterized Kubernetes resource definitions, substituting configurable values for the required parameters. Templates can be core Kubernetes resources as well as CRD defined resources, thus providing access to the full resource model.

### MEC Host Level Management

As described above, the MEC virtualization infrastructure capability can be provided by Kubernetes with extensions to support VMs. Through the defined NF CRDs both VM and container-based capability can be specified and deploy via a common abstraction. Once deployed, the Kubernetes control-plane will monitor the lifecycle of the resources accounting for scalability and high availability. Additionally, Kubernetes provides a security and network infrastructure to support application deployment.

With the additional of the connect-based constraints, scheduler extensions, descheduler, and network mediator, Kubernetes provides the base capabilities required of MEC host level management.

### MEC Host Level Scheduling

MEC host level scheduling is the equivalent of scheduling on a single Kubernetes cluster. The previously described technologies (constraint-based scheduler, optimized scheduler, descheduler, and network mediator) work in concert to provide the scheduling of workloads to nodes.

### MEC Host Level Networking

While a single Kubernetes host provides basic MEC host networking capabilities, though the use of add-on capabilities such as the network service mesh (NSM), additional MEC host (or Kubernetes intra-cluster) networking can be leveraged. A key consideration when deploying a NSM into a Kubernetes cluster is the ability to declaratively define the network connectivity such that there is a separation of concerns between the development of the application and the deployment of the application, i.e., the expected connectivity should not be “baked” into the application code and instead be left to deployment [declarative] configuration. This can be achieved with the NSM implementation.

A network function deployed within a MEC host must focus on serving its intended purpose and should remain unaware of any chaining requirements with other network functions. The Network Service Mesh framework (NSM) in the Kubernetes eco-system fills the role of creating chains and managing the assignment of a network function within a chain. It does so by augmenting orchestrated network functions with a sidecar container and controlling the interactions between the sidecars. The NSM manager can then implement the desired topology by establishing links between sidecars through the NSM data plane.

### MEC System Level Management

The Cloud Native Computing Foundation (CNCF) has defined a special interest group, the Multicluster Special Interest Group (SIG), whose charter specifies that this SIG focuses on “solving common challenges related to the management of multiple Kubernetes clusters.” As indicated above, if a MEC Host represents a single Kubernetes cluster than the MEC system level management is meant to manage multiple MEC Hosts and thus multiple Kubernetes clusters.

The CNCF Multicluster SIG facilitates the development of a solution for deploying workloads across multiple Kubernetes clusters known as “KubeFed”. KubeFed allows an operator to specify the cardinality and location of workloads that are part of an application. Thus, an operator can deploy an application and prescriptively control on which cluster a pod is deployed and how many instances of that Pod are deployed to that cluster. While this is required, it is not sufficient for an autonomous MEC system that can deploy MEC services based on their compute, storage, network, and other resource constraints. The constraint policy extension to Kubernetes described herein that can be applied to a multicluster Kubernetes deployment to provide the capability to deploy MEC services across multiple MEC hosts based on operator specified constraints.

### Why Multi-MEC Host is Needed

In modern deployment architectures a single MEC host is not sufficient to meet the MEC service requirements for latency and/or performance. MEC services will be designed around network and performance bottlenecks, but these designs cannot always compensate for the limitations imposed by the constraints of a single MEC host.

To truly meet the requirements of modern and near future MEC services, deployments must take advantage of multiple MEC host deployments where some of the MEC hosts may be “network close” to the end client with lessor compute power, commonly called edge, and other hosts may be “network distant” with greater computer power.

It is important when deploying a MEC application across multiple MEC hosts that the MEC application is not “topology aware” in that it is not aware of the network location of the compute nor the network on which it is deployed. Instead the MEC application must specify the constraints it requires and allow the “MEC control-plane” to allocate resources to meet the specified constraints. Providing this separation of concerns between the MEC application and the MEC control-plane allows operators to better align their resources and provide the expected quality of service (QOS) to their clients.

### MEC and Edge Computing

Edge computing is the delivery of computing capabilities to the logical extremes of a network to improve the performance, operating cost and reliability of applications and services. Its only property that really matters is the location.

As ETSI GS MEC 003 v2.2.1 (2020 December): Multi-access Edge Computing (MEC); Framework and Reference Architecture; European Telecommunications Standards Institute; states, “Multi-access Edge Computing enables the implementation of MEC applications as software-only entities that run on top of a Virtualization infrastructure, which is located in or close to the network edge.” While this means that MEC can define a network edge capability, it is also true that MEC can define a metro or central data center. In the context of MEC, any Kubernetes cluster is considered a MEC host regardless of the “nearness” to the any given client. As such, at the system level, MEC hosts create a mesh of connectivity that can be leveraged by users that deploy MEC applications.

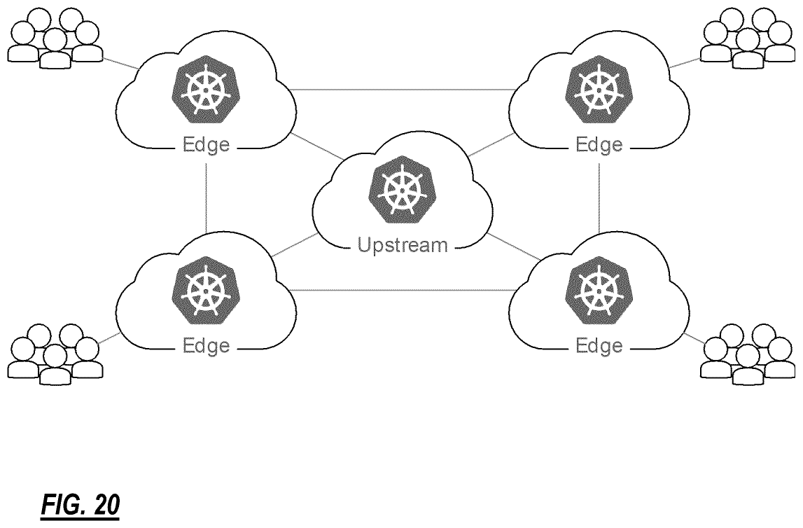

A MEC location capability is simply the MEC host that is “network near” the client of a given MEC application. Thus, any given MEC host may be at the edge to some client regardless of its actual location. FIG. 20 is a diagram of a Kubernetes cluster mesh. FIG. 20 shows an example of how Kubernetes clusters can be inter-connected to represent a MEC host mesh. While some of the clusters are labeled “Edge” or “Upstream” it is important to note that all clusters are functionally equivalent. Where the cluster may differ is in resource capacity or nearness to a given client, but these are operator deployment choice, and an “Edge” could have just as much or more capacity as an “Upstream” cluster.

Based on the above, it is possible to qualify existing or purpose-built MEC hosts as edge clouds for placement of services required by applications that use them. This edge computing requirement driven optimization of network and compute resources also can be achieved by re-configuration of the underlay connecting MEC hosts.

### MEC System Level Scheduling

At the Kubernetes multi-cluster (multi-MEC host level) scheduling is provided via the KubeFed project. At the federation level the scheduling process changes from scheduling a single pod to a node to delegating or replicating Kubernetes resources to a cluster. The constraint-based scheduling described above in the context of a single cluster can be applied at the system level with minor additions to the capabilities.

In KubeFed's existing implementation of scheduling an operator specifies how a resource is federated across the set of member clusters. This includes the specification of the cluster as well as the cardinality of a resource assigned to that cluster. There is a capability to allow the federation to be ratio based as opposed to completely explicit, but this still equates to a prescriptive federation.

By augmenting KubeFed's scheduling algorithm, as it does not provide the same extension mechanism that base Kubernetes provides, constraint-based scheduling, including connect-based constraints, can be achieved. Instead of specifying a cardinality and a cluster the cardinality and connectivity constraints can be specified allowing the scheduler to place the workloads across the multiple clusters. After the workloads are place the constraints can be monitored and upon violation the resources can be rescheduled within the currently assigned cluster or to another cluster.

### MEC System Level Networking

Kubernetes does not provide inter-cluster networking capability natively nor as part of KubeFed project. CNCF provides multicluster DNS capability that can be used in a multi-cluster deployment.

Inter-cluster connectivity can be facilitated via the exposing of cluster services via a standard Kubernetes ingress controller or the NSM. Additionally, as part of the scheduling process a network controller can be used to establish new network paths or modify existing paths.

When using an ingress controller, the services provided through a given cluster are exposed on a public IP address and port. This allows services from other clusters to access these services. The downside of this approach is that it only supports layer 3 (L3) and in some implementations only HTTP connections.

With an NSM implementation inter-cluster networking can be established thought peer to peer connections between NSM managers in each cluster. This allows the establishment of layer 2 (L2) and L3 connections. Further, using sidecars, this connectivity can be declarative maintaining the SOC between application development and application deployment.

Where a network controller can be integrated, either through a scheduler extension or a DevOps pipeline, new network connections can be established that meet the connect-base constraints specified via the constraint policy system. Between the use of the network controller and the NSM complex inter-cluster networking scenarios can be supported.

### Summary

This disclosure described extensions and additions to the standard Kubernetes deployment that provide constraint-base, specifically connect-based constraints, scheduling of Kubernetes workloads. Additionally support for VM as well as container-based workloads was introduced, including chaining of those workloads. How these capabilities can be applied to a single Kubernetes cluster and a federation of Kubernetes clusters was described. Additionally, how these technologies could be applied to non-operator cloud capabilities (i.e., hyper-scaler Kubernetes clusters) was described.

This disclosure then showed how the Kubernetes based technologies could be deployed to provide an architecture that was compliant with the MEC architecture and how the components of the Kubernetes deployment map to the MEC architecture.

In summary, this disclosure has shown how a MEC compliant multi-host system can be deployed using existing CNCF projects with a few key extensions providing a declarative based, autonomous system for MEC service deployments.

### Processing System

FIG. 21 is a block diagram of a processing system 200, which may be used to implement various processes described herein. The processing system 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 21 depicts the processing system 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the processing system 200, a semiconductor-based microprocessor (in the form of a microchip or chipset), or generally any device for executing software instructions. When the processing system 200 is in operation, the processor 202 is configured to execute software stored within the memory 210, to communicate data to and from the memory 210, and to generally control operations of the processing system 200 pursuant to the software instructions. The I/O interfaces 204 may be used to receive user input from and/or for providing system output to one or more devices or components.

The network interface 206 may be used to enable the processing system 200 to communicate on a network, such as the Internet. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the processing system 200, such as, for example, an internal hard drive connected to the local interface 212 in the processing system 200. Additionally, in another embodiment, the data store 208 may be located external to the processing system 200 such as, for example, an external hard drive connected to the I/O interfaces 204 (e.g., SCSI or USB connection). In a further embodiment, the data store 208 may be connected to the processing system 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

In an embodiment, one or more processing systems 200 can be configured in a cluster and/or in a cloud system. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

As described herein, a workload orchestration system can include one or more of the processing devices 200. In another embodiment, a node or pod in a Kubernetes system can be implemented on one or more of the processing devices 200.

### Process

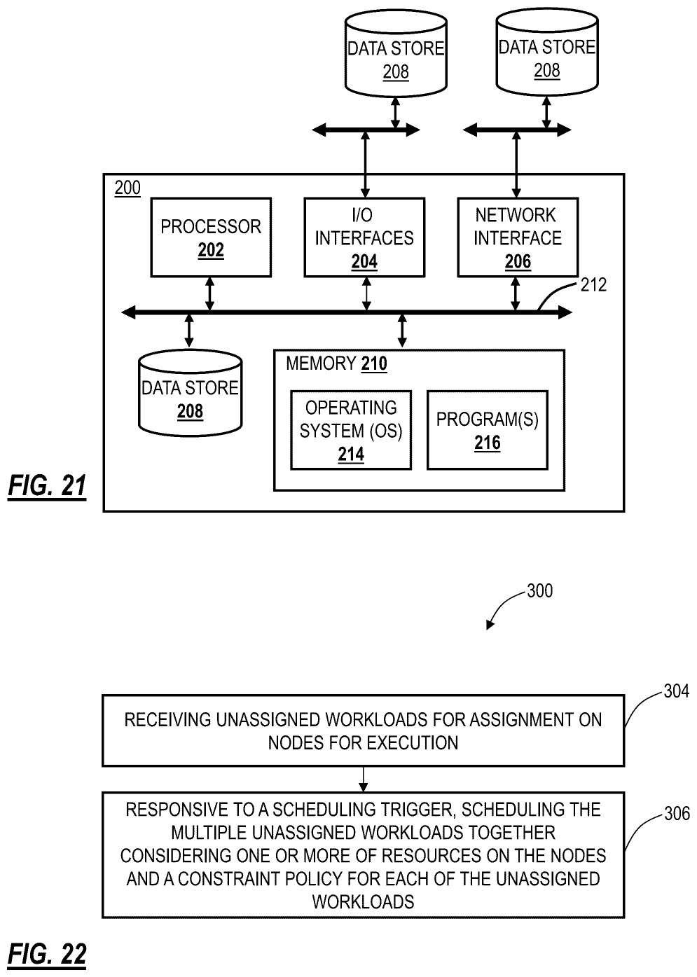

FIG. 22 is a flowchart of a process 300 for a workload orchestration system for extensions to constraint policy and/or scheduling of workloads. Specifically, the present disclosure includes both the extensions to constraint policy and scheduling of workloads. Those skilled in the art will appreciate these two aspects (extensions to constraint policy and scheduling of workloads) contemplate use together as well as individually. In an embodiment, illustrated in FIG. 22, the process 300 includes the scheduling of workloads. The extensions to constraint policy can be used in conjunction with the scheduling of workloads in the process 300. In another embodiment, another process can include the extensions to constraint policy, independent of the scheduling of workloads. In a further embodiment, there can be a tracking process ongoing for the extensions to constraint policy. Those skilled in the art will recognize the various techniques described herein contemplate use individually as well as in various combinations. The various processes including the process 300 contemplate implementation as a method having steps, via the cloud for implementation of steps, via the processing system 200 for implementation of steps, and as a non-transitory computer-readable medium storing instructions that, when executed, cause one or more processors to implement the steps.

The process 300 includes receiving unassigned workloads for assignment on nodes for execution (step 302); and, responsive to a scheduling trigger, scheduling the multiple unassigned workloads together considering one or more of resources on the nodes and a constraint policy for each of the unassigned workloads (step 304). The workload orchestration system can utilize Kubernetes and the one or more workloads are pods in Kubernetes. The unassigned workloads can include any of new workloads and evicted workloads based on their constraint policy. The scheduling trigger can include expiration of an amount of time where no additional unassigned workloads are received. The constraint policy of at least two of the unassigned workloads can include a shared constraint.

The process 300 can include associating the constraint policy to a workload of the unassigned workload being managed by the workload orchestration system; subsequent to the scheduling and implementation of the workload, tracking compliance of the workload to the constraint policy; and, responsive to a violation of the compliance, performing one or more of ignoring the violation, mediating the violation to meet the compliance, and evicting the workload to restart the workload. The constraint policy can include one or more constraint rules. The one or more constraint rules can include at least one network connectivity constraints including any of bandwidth, latency, and jitter. The one or more constraint rules can include a name, a requested value, and a limit value.

### Conclusion

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

### REFERENCES

The following references are incorporated by reference in their entirety:
ETSI GS MEC 003 v2.2.1 (2020 December): Multi-access Edge Computing (MEC); Framework and Reference Architecture; European Telecommunications Standards Institute; available online at: www.etsi.org/deliver/etsi_gs/MEC/001_099/003/02.02.01_60/gs_MEC003v020201p.pdf
Kubernetes Documentation: Glossary (10 Aug. 2021); available online at: kubernetes.io/docs/reference/glossary/?all=true#term-cluster
Helm: project home page (10 Aug. 2021); available online at helm.sh/
CNCF Multicluster Special Interest group (10 Aug. 2021); available online at github.com/kubernetes/community/tree/master/sig-multicluster
CNCF Node Feature Discovery (10 Aug. 2021); available online at github.com/kubernetes-sigs/node-feature-discovery
CNCF Descheduler (10 Aug. 2021); available online at github.com/kubernetes-sigs/descheduler
ETSI GR NFV-IFA 029 V3.3.1 (2019 November): Network Functions Virtualisation (NFV) Release 3; Architecture; Report on the Enhancements of the NFV architecture towards “Cloud-native” and “PaaS”; European Telecommunications Standards Institute; available online at www.etsi.org/deliver/etsi_gr/NFV-IFA/001_099/029/03.03.01_60/gr_NFV-IFA029v030301p.pdf
ETSI GS NFV-IFA 040 V4.2.1 (2021 August): Network Functions Virtualisation (NFV) Release 4; Management and Orchestration; Requirements for service interfaces and object model for OS container management and orchestration specification; European Telecommunications Standards Institute; available online at www.etsi.org/deliver/etsi_gs/NFV-IFA/001_099/040/04.02.01_60/gs_NFV-IFA040v040201p.pdf
Global System for Mobile Communications (13 Aug. 2021): 5G Operator Platform; available online at www.gsma.com/futurenetworks/5g-operator-platform/
Kubernetes Documentation (13 Aug. 2021): available online at kubernetes.io/docs/home/
Kubernetes Components (13 Aug. 2021), available online at kubernetes.io/docs/concepts/overview/components/
Sawaya, S. (2020 Mar. 25) Is Kubernetes the Cure to Cantankerous 5G Core? available online at www.sdxcentral.com/articles/news/is-kubernetes-the-cure-to-cantankerous-5g-core/2020/03/
Vaughan-Nichols, S. J. (2019 May 2) 5G depends on Kubernetes in the cloud available online at www.zdnet.com/article/5g-depends-on-kubernetes-in-the-cloud/
Engebretson, J. (2019 Feb. 7) Will Kubernetes Be the Operating System for 5G? AT&T News Suggests Yes available online at www.telecompetitor.com/will-kubernetes-be-the-operating-system-for-5g-att-news-suggests-yes/
Robuck, M. (2019 Jul. 15) Verizon and Ericsson turn up cloud-native and containers in a wireless core trial available online at www.fiercetelecom.com/telecom/verizon-and-ericsson-turn-up-cloud-native-and-containers-a-wireless-core-trial
Meyer, D. (2020 Aug. 20) Cisco CN-WAN Smashes Together SD-WAN and Kubernetes, Retrieved from sdxcentral.com available online at www.sdxcentral.com/articles/news/cisco-cn-wan-smashes-together-sd-wan-and-kubernetes/2020/08/.

What is claimed is:

1. A non-transitory computer-readable medium comprising instructions that, when executed, cause a workload orchestration system including at least one processor to perform steps of:
receiving unassigned workloads for assignment on nodes for execution; and
responsive to a scheduling trigger, scheduling the multiple unassigned workloads together considering one or more of resources on the nodes and a constraint policy for each of the unassigned workloads.

2. The non-transitory computer-readable medium of claim 1, wherein the workload orchestration system utilizes Kubernetes and the one or more workloads are pods in Kubernetes.

3. The non-transitory computer-readable medium of claim 1, wherein the unassigned workloads include any of new workloads and evicted workloads based on their constraint policy.

4. The non-transitory computer-readable medium of claim 1, wherein the scheduling trigger includes expiration of an amount of time where no additional unassigned workloads are received.

5. The non-transitory computer-readable medium of claim 1, wherein the constraint policy of at least two of the unassigned workloads includes a shared constraint.

6. The non-transitory computer-readable medium of claim 1, wherein the steps further include
associating the constraint policy to a workload of the unassigned workload being managed by the workload orchestration system;
subsequent to the scheduling and implementation of the workload, tracking compliance of the workload to the constraint policy; and
responsive to a violation of the compliance, performing one or more of ignoring the violation, mediating the violation to meet the compliance, and evicting the workload to restart the workload.

7. The non-transitory computer-readable medium of claim 6, wherein the constraint policy includes one or more constraint rules.

8. The non-transitory computer-readable medium of claim 7, wherein the one or more constraint rules include at least one network connectivity constraints including any of bandwidth, latency, and jitter.

9. The non-transitory computer-readable medium of claim 7, wherein the one or more constraint rules include a name, a requested value, and a limit value.

10. A method comprising steps of:
receiving unassigned workloads for assignment on nodes for execution; and
responsive to a scheduling trigger, scheduling the multiple unassigned workloads together considering one or more of resources on the nodes and a constraint policy for each of the unassigned workloads.

11. The method of claim 10, wherein the workload orchestration system utilizes Kubernetes and the one or more workloads are pods in Kubernetes.

12. The method of claim 10, wherein the unassigned workloads include any of new workloads and evicted workloads based on their constraint policy.

13. The method of claim 10, wherein the scheduling trigger includes expiration of an amount of time where no additional unassigned workloads are received.

14. The method of claim 10, wherein the constraint policy of at least two of the unassigned workloads includes a shared constraint.

15. The method of claim 10, wherein the steps further include
associating the constraint policy to a workload of the unassigned workload being managed by the workload orchestration system;
subsequent to the scheduling and implementation of the workload, tracking compliance of the workload to the constraint policy; and
responsive to a violation of the compliance, performing one or more of ignoring the violation, mediating the violation to meet the compliance, and evicting the workload to restart the workload.

16. The method of claim 15, wherein the constraint policy includes one or more constraint rules.

17. A workload orchestration system comprising:
at least one processor and memory storing instructions that, when executed, cause the at least one processor to
receive unassigned workloads for assignment on nodes for execution, and
responsive to a scheduling trigger, schedule the multiple unassigned workloads together considering one or more of resources on the nodes and a constraint policy for each of the unassigned workloads.

18. The workload orchestration system of claim 17, wherein the workload orchestration system utilizes Kubernetes and the one or more workloads are pods in Kubernetes.

19. The workload orchestration system of claim 17, wherein the unassigned workloads include any of new workloads and evicted workloads based on their constraint policy.

20. The workload orchestration system of claim 17, wherein the scheduling trigger includes expiration of an amount of time where no additional unassigned workloads are received.
